(19) United States
(12) Patent Application Publication
(10) Pub. No.: US 2025/0368055 A1
(43) Pub. Date: Dec. 4, 2025

(54) ELECTRICAL POWER SYSTEM, POWER SUPPLY APPARATUS, POWER CONVERTER, AND CONTROLLER

(71) Applicant: FUJI ELECTRIC CO., LTD., Kanagawa (JP)

(72) Inventors: Ryuji YAMADA, Tokyo (JP); Kazuyuki YODA, Hyogo (JP)

(21) Appl. No.: 18/677,003

(22) Filed: May 29, 2024

(51) Int. Cl. B60L 50/60; B60L 15/00; B60L 53/24; B60L 55/00

(52) U.S. Cl. CPC B60L 50/60; B60L 15/007; B60L 53/24; B60L 55/00

(57) ABSTRACT

An electrical power system includes a high voltage battery and an electric motor provided in a vehicle, an inverter device to convert an output of the high voltage battery into an alternating current to drive the electric motor, a power line extending from a neutral point of an armature of the electric motor, a charge and discharge port provided on the vehicle and connected to a tip end of the power line, a power supply system provided in a house, and a charging and discharging cable having a tip end electrically connectable to the charge and discharge port, wherein the high voltage battery is chargeable with the electric power supplied from the power supply system via the inverter device, the neutral point, the power line, and the charging and discharging cable, and the electric power is dischargeable from the high voltage battery to the power supply system.

### FIELD

The present disclosure relates to electrical power systems, power supply apparatuses, power converters, and controllers.

### BACKGROUND

For example, a technique for connecting a house or a facility and an electric vehicle provided with a storage battery so that electric power can be exchanged therebetween, charging the storage battery by supplying electric power from the house or the like, and discharging the electric power of the storage battery to an electric load in the house or the like, is known from Japanese Laid-Open Patent Publication No. 2018-61432, for example.

However, it is necessary to convert an alternating current into a direct current when charging the storage battery by the electric power of the house or the like, and it is necessary to convert the direct current into the alternating current when discharging the electric power of the storage battery to the electric load in the house or the like. For this reason, it may be necessary to provide a power converter for charging and discharging the storage battery in the vehicle, the house, or the like.

### SUMMARY

One object of the present disclosure is to provide a technique capable of exchanging electric power between a vehicle provided with a storage battery and a house or the like, using a simple configuration.

In order to achieve the object described above, one embodiment of the present disclosure provides an electrical power system comprising:
a storage battery provided in a vehicle;
an electric motor provided in the vehicle;
a first power converter electrically connected to both the storage battery and the electric motor in the vehicle, and configured to convert an output of the storage battery into an alternating current to drive the electric motor;
a first power line extending from a neutral point of an armature of the electric motor in the vehicle;
a power supply system provided in a house or a facility; and
a power connection part configured to electrically connect the power supply system and the first power line such that electrical power is exchangeable therebetween,
wherein the storage battery is chargeable with the electric power supplied from the power supply system via the first power converter, the neutral point, the first power line, and the power connection part, and the electric power is dischargeable from the storage battery to the power supply system.

Another embodiment of the present disclosure provides a power supply apparatus provided in a house or a facility, and capable of exchanging an electric power, via a power connection part, with a vehicle including a storage battery, an electric motor, a power converter electrically connected to both the storage battery and the electric motor and configured to convert an output of the storage battery into an alternating current to drive the electric motor, and a power line extending from a neutral point of an armature of the electric motor, wherein:
the power supply apparatus is electrically connected to each of an electric load in the house or the facility, the power connection part, and a predetermined power source;
the storage battery is charged with an electric power of the predetermined power source by supplying an alternating current of the predetermined power source to the power line via the power connection part; and
an electric power of the storage battery is discharged to the electric load by supplying an alternating current supplied from the power line to the electric load via the power connection part.

Still another embodiment of the present disclosure provides a power converter provided in a vehicle including a storage battery, an electric motor, and a power line extending from a neutral point of an armature of the electric motor, the power converter being electrically connected to both the storage battery and the electric motor and converting a direct current of the storage battery into an alternating current to drive the electric motor, the power converter performing a process comprising:
converting an alternating current supplied to the power line from a predetermined power source outside the vehicle via a power connection part into a direct current and outputting the direct current to the storage battery to charge the storage battery with an electric power of the predetermined power source; and
discharging an electric power of the storage battery to an electric load in a house or a facility, by converting an output of the storage battery into an alternating current, outputting the alternating current to the armature side, and supplying the alternating current to the electric load via the neutral point, the power line, and the power connection part.

A further embodiment of the present disclosure provides a controller of an electric power system having a storage battery provided in a vehicle, an electric motor provided in the vehicle, a power converter electrically connected to both the storage battery and the electric motor in the vehicle, and configured to convert an output of the storage battery into an alternating current to drive the electric motor, a power line extending from a neutral point of an armature of the electric motor in the vehicle, a power supply system provided in a house or a facility, a power connection part configured to electrically connect the power supply system and the power line such that electrical power is exchangeable therebetween, and a power supply apparatus provided in the power supply system and electrically connected to each of an electric load in the house or the facility, the power connection part, and a predetermined power source, the controller performing a process comprising:
controlling the power supply apparatus to supply an alternating current of the predetermined power source to the power line via the power connection part, and controlling the power converter to convert an alternating current supplied to the power line into a direct current and output the direct current to the storage battery to charge the storage battery with an electric power of the predetermined power source; and
controlling the power converter to convert the output of the storage battery into an alternating current and output the alternating current to the armature side, and supply the alternating current to the power supply system via the neutral point, the power line, and the power connection part, and controlling the power supply apparatus to supply an electric power to the electric load to discharge an electric power of the storage battery to the electric load.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a diagram illustrating a first example of an electrical power system.

FIG. 2 illustrates a first example of a circuit configuration related to electric power exchange between a power supply system of a house and an electric vehicle.

FIG. 3 illustrates a second example of the circuit configuration related to the electric power exchange between the power supply system of the house and the electric vehicle.

FIG. 4 is a diagram illustrating a second example of the electrical power system.

FIG. 5 illustrates a third example of a circuit configuration related to the electric power exchange between the power supply system of the house and the electric vehicle.

FIG. 6 illustrates a fourth example of the circuit configuration related to the electric power exchange between the power supply system of the house and the electric vehicle.

### DESCRIPTION OF EMBODIMENTS

Hereinafter, embodiments will be described with reference to the drawings.

### [First Example of Electrical Power System]

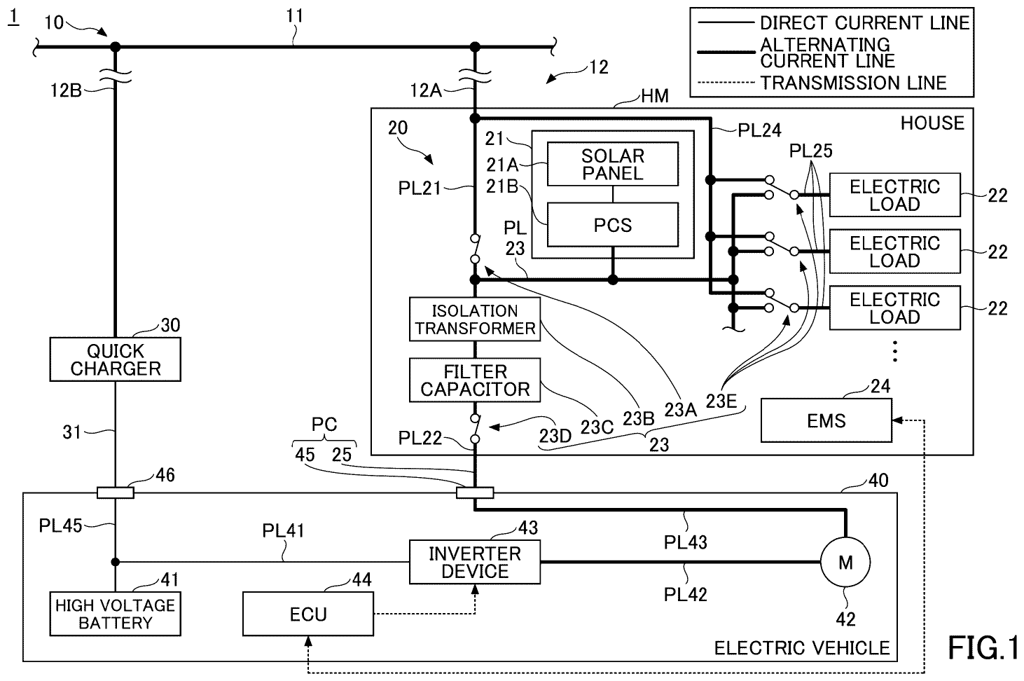

A first example of an electrical power system 1 according to the present embodiment will be described with reference to FIG. 1 through FIG. 3.

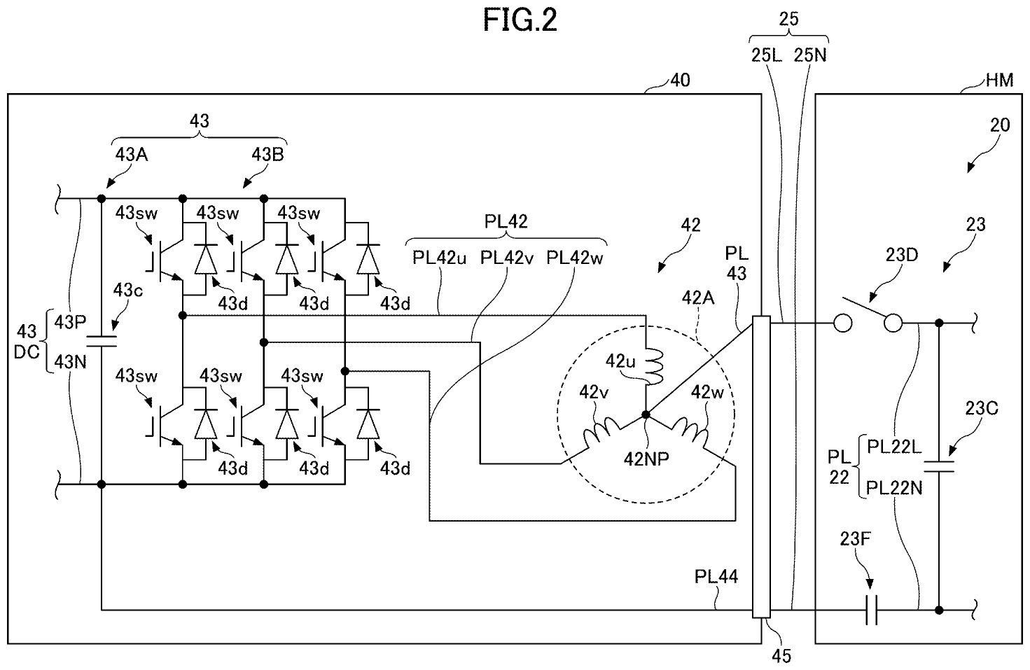

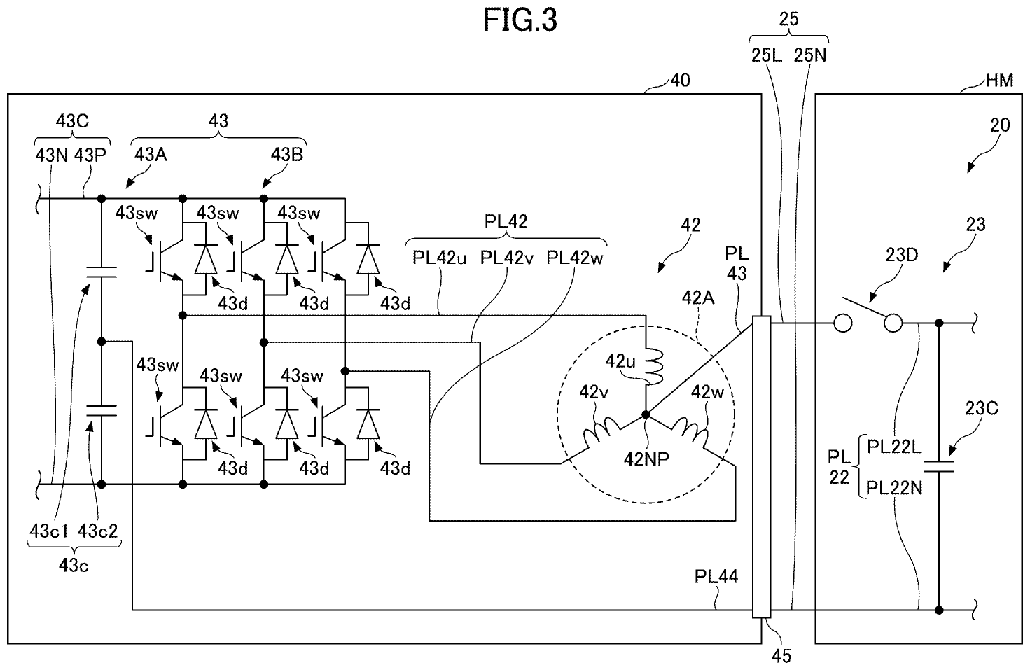

FIG. 1 is a diagram illustrating an example of the electrical power system 1. FIG. 2 is a diagram illustrating a first example of a circuit configuration related to electric power exchange between a power supply system 20 of a house HM and an electric vehicle 40. FIG. 3 is a diagram illustrating a second example of the circuit configuration related to the electric power exchange between the power supply system 20 of the house HM and the electric vehicle 40.

For the sake of convenience, FIG. 1 illustrates a state wherein the electric vehicle 40 is electrically connected to both the power supply system 20 of the house HM and a quick charger 30, but normally, a power supply system of the electric vehicle 40 is electrically connected to only one of the power supply system 20 of the house HM and the quick charger 30.

### <Overview of Electrical Power System>

An overview of the electrical power system 1 will be described with reference to FIG. 1.

As illustrated in FIG. 1, the electrical power system 1 according to the present example includes a power grid 10, the power supply system 20, the quick charger 30, and the electric vehicle 40.

The power grid 10 generates, transmits, and converts electric power, and distributes the electric power to a customer.

The power supply system 20 is provided in the house HM, and exchanges electric power with an outside of the house HM, such as the power grid 10, the electric vehicle 40, or the like, and distributes the electric power in the house HM. The house HM may be an independent house, or an apartment, for example.

The power supply system 20 may be provided in some kind of a facility, exchange electric power with an outside of the facility, such as the power grid 10, the electric vehicle 40, or the like, and distribute the electric power in the facility. The arrangement may be the same for a second example which will be described later.

The quick charger 30 is electrically connected to the electric vehicle 40 via a charging cable 31, and performs a so-called quick charging of a high voltage battery 41 of the electric vehicle 40 by supplying direct current (DC) power of a relatively high voltage (for example, 350 volts (V)).

The electric vehicle 40 is provided with the high voltage battery 41, and drives an electric motor 42, which is an example of a motor, with the electric power of the high voltage battery 41, thereby driving wheels by the power of the electric motor 42 to cause the electric vehicle 40 to travel. The electric vehicle 40 is a battery electric vehicle (BEV), a hybrid electric vehicle (HEV), a plug-in hybrid electric vehicle (PHEV), a fuel cell vehicle (FCV), or the like, for example. The electric vehicle 40 is electrically connectable to the power supply system 20 of the house HM via a charging and discharging cable 25. Accordingly, the electric vehicle 40 can convert an alternating current supplied from the power supply system 20 into a direct current to charge the high voltage battery 41, and can convert the electric power of the high voltage battery 41 into an alternating current to discharge the electric power to the power supply system 20 of the house HM.

The electric vehicle 40 may be parked in a parking space adjacent to the house HM. The electric vehicle 40 is a private car used by a resident of the house HM, for example. Further, the electric vehicle 40 may be a car sharing vehicle deployed in the parking space adjacent to the house HM. The electric vehicle 40 is electrically connected to the power supply system 20 when a user of the electric vehicle 40 or the resident of the house HM connects a connector on a tip end of the charging and discharging cable 25 provided at the house HM to a charge and discharge port 45 of the electric vehicle 40, in a state where the electric vehicle 40 is parked in the parking space of the house HM. Accordingly, the electrical power system 1 can exchange electric power between the power supply system 20 of the house HM and the high voltage battery 41 of the electric vehicle 40 via the charging and discharging cable 25. Hereinafter, in the present specification, a case where the electric vehicle 40 is parked in the parking space of the house HM will be mainly described.

A quick charging function using the quick charger 30 may be omitted in the electric vehicle 40. The arrangement may be the same for the second example which will be described later.

### <Configuration of Electrical Power System>

Next, a configuration of the electrical power system 1 will be described with reference to FIG. 2 and FIG. 3, in addition to FIG. 1.

### «Configuration of Power Grid»

The power grid includes a power transmission system 11 and a power distribution system 12.

The power transmission system 11 transmits alternating current (AC) power. The power distribution system 12 branches from the power transmission system 11, and distributes the AC power transmitted by the power transmission system 11 to the customer. The power distribution system 12 includes power distribution systems 12A and 12B.

The power distribution system 12A distributes power to the power supply system 20 of the house HM. For example, the power distribution system 12A distributes a single-phase AC power of 200 volts (V) to the power supply system 20 of the house HM by a single-phase three-wire system.

The power distribution system 12B distributes power to the quick charger 30. For example, the power distribution system 12B distributes three-phase AC power of 200 V to the quick charger 30 by a three-phase three-wire system.

### «Configuration of Power Supply System»

The power supply system 20 of the house HM includes power lines PL21 to PL25, a solar power generator 21, electric loads 22, a power supply apparatus 23, an energy management system (EMS) 24, and the charging and discharging cable 25.

The power lines PL21 to PL25 are AC power lines. The power line PL21 has one end thereof connected to the power distribution system 12A, and the other end thereof connected to the power line PL22 and the power line PL23. The power line PL22 has one end thereof connected to a base end of the charging and discharging cable 25, and the other end thereof connected to the power line PL21 and the power line PL23. The power line PL23 has one end thereof connected to the power line PL21 and the power line PL22, and the other end thereof connected to a plurality of power lines PL25 via a plurality of switches 23E. The power line PL24 has one end thereof connected to the power distribution system 12A, and the other end thereof connected to the plurality of power lines PL25 via the plurality of switches 23E. Each power line PL25 supplies the electric power supplied from one of the power lines PL23 and PL24 to the electric load 22 via the switch 23E.

The solar power generator 21 includes a solar panel 21A, and a power conditioning system (PCS) 21B.

The solar panel 21A converts solar energy into electrical energy and outputs the electrical energy. The PCS 21B converts a DC output of the solar panel 21A into an AC output and outputs the AC output to the power line PL23. In this state, the PCS 21B can efficiently extract the electric power from the solar panel 21A, by operating to search for an optimum operating point according to a known maximum power point tracking (MPPT) technique, for example.

For example, the solar power generator 21 can supply the electric power from the power line PL23 to the electric load 22 via the power line PL25. The solar power generator 21 can be interconnected with the power grid 10 from the power line PL23 via the power line PL21, to supply the electric power to the power grid 10. The solar power generator 21 can supply the electric power from the power line PL23 to the electric vehicle 40 via the power line PL22 and the charging and discharging cable 25.

The solar power generator 21 may be omitted. The arrangement may be the same for the second example which will be described later. In addition, the house HM may be provided with another power source in place of or in addition to the solar power generator 21. The other power source may be a fuel cell or a generator which uses a motor, such as a gas engine, a gas turbine, or the like, for example. Moreover, the other power source may be other types of renewable energy derived power source, such as a wind power generator, a geothermal generator, or the like, for example. The arrangement may be the same for the second example which will be described later.

The electric load 22 is activated by the AC power from the power line PL25. For example, the electric load 22 may include at least one of an electric load fixedly and electrically connected to the power line PL25, and an electric load detachably and electrically connected to an outlet on a tip end of the power line PL25.

The power supply apparatus 23 is electrically connected to the power distribution system 12A, the charging and discharging cable 25, and the electric load 22 via the power lines PL21 to PL25, and exchanges electric power inside the power supply system 20, and exchanges electric power with the outside of the power supply system 20. The power supply apparatus 23 includes a switch 23A, an isolation transformer 23B, a filter capacitor 23C, a switch 23D, and the plurality of switches 23E.

The switch 23A is provided on the power line PL21. The switch 23A is configured to be able to electrically open and close the power line PL21 under a control of the EMS 24. Accordingly, the power supply system 20 of the house HM can be switched between a state where the power distribution system 12A and the power lines PL22 and PL23 are electrically connected, and a state where the power distribution system 12A and the power lines PL22 and PL23 are electrically disconnected.

The isolation transformer 23B is provided on the power line PL22, and exchanges the AC power between the side of the power line PL22 closer to the charging and discharging cable 25 and the side of the power line PL22 closer to the power lines PL21 and PL23, while isolating the powered device from the power source.

The filter capacitor 23C is provided between the isolation transformer 23B on the power line PL22 and the charging and discharging cable 25. The filter capacitor 23C eliminates a high-frequency component of an output current of the inverter device 43 in the electric vehicle 40. Specifically, as illustrated in FIG. 2 and FIG. 3, the filter capacitor 23C is disposed on a power line that connects two power lines PL22L and PL22N forming the power line PL22. Hence, the filter capacitor 23C does not need to be provided in the electric vehicle 40, and it is thus possible to prevent an increase in the cost and weight of the electric vehicle 40.

The switch 23D is provided between the isolation transformer 23B on the power line PL22 and the charging and discharging cable 25, and is configured to be able to electrically open and close the power line PL22 under the control of the EMS 24. For example, as illustrated in FIG. 2 and FIG. 3, the switch 23D is provided on the power line PL22L. Accordingly, the EMS 24 can switch the power supply system 20 of the house HM and the electric vehicle 40 between the electrically connected state and the electrically disconnected state, by switching the open and closed states of the switch 23D.

Functions of the filter capacitor 23C and the switch 23D may be provided in the electric vehicle 40. For example, a filter capacitor similar to the filter capacitor 23C may be provided on a power line connecting power lines PL43 and PL44 of the electric vehicle 40. In addition, a switch similar to the switch 23D may be provided on the power line PL43 of the electric vehicle 40.

The switch 23E is provided for each of the plurality of power lines PL25. The switch 23E is configured to switch between a state where the power line PL25 is electrically connected to the power line PL23 and a state where the power line PL25 is electrically connected to the power line PL24 under the control of the EMS 24. Thus, in a case where the electric power is supplied from the high voltage battery 41 of the electric vehicle 40 to the power supply system 20, the switch 23E can selectively switch between a state where the electric power from the high voltage battery 41 is supplied to the electric load 22 via the power lines PL22 and PL23, and a state where the electric power from the power distribution system 12A is supplied to the electric load 22 via the power line PL24, under the assumption that the switch 23A is in the open state.

The switch 23E may be provided for only some of the plurality of power lines PL25. In this case, the power line PL25 that is not provided with the switch 23E is connected to the power line PL23. Thus, in a case where the electric power is supplied from the high voltage battery 41 to the power supply system 20, the power supply system 20 can fixedly supply the electric power from the high voltage battery 41 to the electric load 22 connected to the electric power line PL25 that is not provided with the switch 23E, among the plurality of electric loads 22. The arrangement may be the same for the second example which will be described later. Further, the switches 23E themselves may be omitted in their entirety. In this case, all the power lines PL25 are connected to the power line PL23, and the power line PL24 may be omitted. The arrangement may be the same for the second example which will be described later.

As illustrated in FIG. 2, the power supply apparatus 23 may include a DC blocking capacitor 23F. The DC blocking capacitor 23F is provided on the power line PL22N between a power line 25N of the charging and discharging cable 25 and the isolation transformer 23B.

The EMS 24 performs the control related to the power supply system 20 of the house HM.

Functions of the EMS 24 may be implemented by arbitrary hardware or a combination of arbitrary hardware and software. For example, the EMS 24 may be mainly configured by a computer including a central processing unit (CPU), a memory device, an auxiliary storage device, and an interface device. The EMS 24 can implement various functions by loading a program installed in the auxiliary storage device into the memory device and causing the CPU to execute the program. The memory device is a static random access memory (SRAM) or a dynamic random access memory (DRAM), for example. The auxiliary storage device is a hard disc drive (HDD), a solid state drive (SSD), an electrically erasable programmable read only memory (EEPROM), a flash memory, or the like, for example. The interface device includes an external interface to be connected to a recording medium, or a communication interface for communicating with the outside, for example. Hence, the EMS 24 can install the program and data required by a process from the recording medium into the auxiliary storage device via the external interface, for example. In addition, the EMS 24 can communicate with various devices (for example, switches 23A, 23D, 23E, or the like) of the power supply system 20 of the house HM or external devices (for example, the ECU 44 of the electric vehicle 40) outside the power supply system 20 of the house HM via the communication interface. Moreover, the EMS 24 can download the program and data required by the process from the external device using the communication interface, and install the program and data into the auxiliary storage device, for example.

In the present example, the EMS 24 performs the control related to the exchange of electric power between the power supply system 20 of the house HM and the electric vehicle 40, in cooperation with the ECU 44 of the electric vehicle 40 by two-way communication with the ECU 44. The communication between the EMS 24 and the ECU 44 may be performed by cable communication using the charging and discharging cable 25 as an example of a transmission path, for example, or may be performed by wireless communication using a predetermined short-range communication, such as Bluetooth (registered trademark), WiFi (registered trademark), or the like, for example.

For example, in a case where the EMS 24 causes the power supply system 20 of the house HM to supply the electric power to the electric vehicle 40, the EMS 24 transmits a command to the ECU 44 to appropriately operate the inverter device 43 of the electric vehicle 40 so as to convert the alternating current from the power supply system 20 into the direct current. Accordingly, the EMS 24 can control the inverter device 43 via the ECU 44, and charge the high voltage battery 41 of the electric vehicle 40 with the electric power from the power supply system 20 of the house HM. The electric power supplied from the power supply system 20 to the electric vehicle 40 may be the electric power generated by the solar power generator 21, or the electric power from the power distribution system 12A, or both the electric power generated by the solar power generator 21 and the electric power from the power distribution system 12A. In the case where the electric power is supplied from the power supply system 20 to the electric vehicle 40 using only the electric power generated by the solar power generator 21, the EMS 24 controls the switch 23A to the open state.

On the other hand, in a case where the EMS 24 causes the high voltage battery 41 of the electric vehicle 40 to discharge to the power supply system 20 of the house HM, the EMS 24 transmits a command to the ECU 44 to appropriately operate the inverter device 43 of the electric vehicle 40 so as to convert the output of the high voltage battery 41 into an alternating current. Accordingly, the EMS 24 controls the inverter device 43 via the ECU 44 to discharge the electric power of the high voltage battery 41 of the electric vehicle 40 to the power supply system 20 of the house HM, thereby achieving the power supply from the electric vehicle 40 to the power supply system 20 of the house HM.

In addition, in a case where the electric power is not exchanged between the power supply system 20 of the house HM and the electric vehicle 40, the EMS 24 controls the switch 23D to the open state. Accordingly, even in the state where the connector on the tip end of the charging and discharging cable 25 is connected to the charge and discharge port 45 of the electric vehicle 40, for example, it is possible to prohibit the exchange between the power supply system 20 of the house HM and the electric vehicle 40.

Moreover, in a case where the EMS 24 causes the high voltage battery 41 of the electric vehicle 40 to discharge to the power supply system 20 of the house HM, the EMS 24 controls the switch 23A to the open state. Accordingly, the EMS 24 can prohibit the interconnection between the power supply system of the electric vehicle 40 and the power grid 10 via the power supply system 20 of the house HM. For this reason, the electrical power system 1 can achieve the power supply from the high voltage battery 41 of the electric vehicle 40 to the power supply system 20 of the house HM, using the inverter device 43 of the electric vehicle 40 which is difficult to satisfy the interconnection requirements with respect to the power grid 10.

Further, in the case where the EMS 24 causes the high voltage battery 41 of the electric vehicle 40 to discharge to the power supply system 20 of the house HM, the EMS 24 controls some of the switches 23E among the plurality of switches 23E to the state connecting the power lines PL23 and PL25, and controls the remaining switches 23E to the state connecting the power lines PL24 and PL25. Accordingly, in the case where the electric power is supplied from the high voltage battery 41 of the electric vehicle 40 to the power supply system 20 of the house HM, the EMS 24 can restrict supplying destinations of the electric power to some of the electric loads 22. For this reason, even in a case where the electric power supplied from the high voltage battery 41 cannot cover the electric power to be supplied to all of the electric loads 22, the EMS 24 can supply the electric power of the high voltage battery 41 to some of the electric loads 22 and supply the electric power from the power distribution system 12A to the remaining electric loads 22. The switch 23E can selectively switch a connecting destination of the electric load 22 between the power lines PL23 and PL24. Hence, the EMS 24 can avoid the electric vehicle 40 from being interconnected with the power grid 10, while supplying the electric power from the power distribution system 12A to the remaining electric loads 22. Some of the switches 23E that are controlled to the state connecting the power lines PL23 and PL25 may be fixed in advance, or may be varied by a setting operation performed by the resident or the like of the house HM. As described above, the switch 23E may be provided on only some of power lines PL25 among the plurality of power lines PL25, and the power lines PL25 not provided with the switch 23E may be connected to the power line PL23. In this case, when discharging from the high voltage battery 41 to the power supply system 20 of the house HM, the EMS 24 may be configured to control some of the switches 23E among the plurality of switches 23E to the state connecting the power lines PL23 and PL25 and control the remaining switches 23E to the state connecting the power lines PL24 and PL25, similar to the above, or configured to control all of the switches 23E to the state connecting the power lines PL24 and PL25.

The EMS 24 may communicate with the PCS 21B of the solar power generator 21 via a transmission path, such as a one-to-one communication line or the like, to grasp a surplus power of the solar power generator 21, and charge the high voltage battery 41 of the electric vehicle 40 with the surplus power. Specifically, in a case where the surplus power of the solar power generator 21 is generated or is likely generated, the EMS 24 may check an energy storage rate of the high voltage battery 41 through communication with the ECU 44. In a case where the energy storage rate of the high voltage battery 41 is small relative to a predetermined reference, the EMS 24 may determine that the surplus power of the solar power generator 21 can be received, and control the inverter device 43 via the ECU 44 to charge the high voltage battery 41 of the electric vehicle 40 with the surplus power of the solar power generator 21. The state where the energy storage rate of the high voltage battery 41 is small relative to the predetermined reference may mean that the energy storage rate of the high voltage battery 41 is the predetermined reference or less, or that the energy storage rate of the high voltage battery 41 is less than the predetermined reference.

The surplus power of the solar power generator 21 corresponds to a part of the electric power that can be output from the solar power generator 21, exceeding a sum of the electric power consumed by the electric loads 22 and the electric power that can be output from the solar power generator 21 to the power grid 10, for example. For example, the surplus power of the solar power generator 21 may occur in response to an output control command issued with respect to the solar power generator 21 from an aggregator or the like due to a grid congestion, during daytime when an electric power output of solar power generators, including the solar power generator 21 and interconnected with the power grid 10, is relatively large.

The grid congestion refers to a situation where the load on the power grid 10 becomes very high, such as when an available power transmission capacity becomes very small in at least a part of the power transmission system 11, for example, due to an increase in the amount of electric power supplied from the power sources, such as the solar power generators or the like, connected to the power grid 10 via an interconnection line. In addition, the surplus power of the solar power generator 21 may be generated in a case where a rate of change with respect to time of the output (rate of change of output) of the solar power generator 21 increases and exceeds an upper limit value defined by interconnection requirements of the solar power generator 21 with respect to the power grid 10, during the daytime when the electric power output of the solar power generator 21 increases.

The EMS 24 may grasp a power shortage of the solar power generator 21 and discharge the electric power from the high voltage battery 41 of the electric vehicle 40 to the power supply system 20 of the house HM so as to compensate for the power shortage. Specifically, in a case where the power shortage is generated or is likely generated in the solar power generator 21, the EMS 24 may grasp the energy storage rate of the high voltage battery 41 through communication with the ECU 44. Further, in a case where the energy storage rate of the high voltage battery 41 is large relative to the predetermined reference, the EMS 24 may determine that the electric power of the high voltage battery 41 can be discharged, and control the inverter device 43 via the ECU 44 to discharge the electric power of the high voltage battery 41 to the power supply system 20 of the house HM. The state where the energy storage rate of the high voltage battery 41 is large relative to the predetermined reference may mean that the energy storage rate of the high voltage battery 41 is the predetermined reference or greater, or that the energy storage rate of the high voltage battery 41 exceeds the predetermined reference. Accordingly, the electrical power system 1 can compensate for a part or all of the power shortage of the solar power generator 21 with the electric power of the high voltage battery 41, and as a result, can reduce the amount of electric power used from the power grid 10 in the power supply system 20 of the house HM.

The power shortage of the solar power generator 21 corresponds to a part of the electric power consumed by the electric loads 22 exceeding the electric power that can be output by the solar power generator 21, for example. For example, the power shortage of the solar power generator 21 may occur at night when the electric power output of the solar power generator 21 becomes zero and the amount of electric power consumed by the electric loads 22 increases.

Accordingly, the EMS 24 can cause the high voltage battery 41 to absorb the power fluctuation of the solar power generator 21 in cooperation with the ECU 44 of the electric vehicle 40. For this reason, the EMS 24 can effectively utilize the energy of the solar power generator 21. Moreover, in a case where the use of the electric vehicle 40 is limited to holidays or the like, for example, the time during which the electric vehicle 40 is parked in the parking space of the house HM and is connected to the power supply system 20 via the charging and discharging cable 25 may be relatively long. In this case, a capacity of a storage battery provided in the house HM for absorbing the output fluctuation of the solar power generator 21, can be set to a relatively small value, and as a result, a facility investment in the home HM can be reduced.

In addition, dynamic pricing may be employed for the power supply from the power distribution system 12A to the power supply system 20. The dynamic pricing is a system that dynamically varies a price or power rate of the electric power supplied from the power grid 10 according to a demand situation of the electric power of the power grid 10. In this case, the EMS 24 may control the exchange of electric power between the power supply system 20 and the high voltage battery 41 according to the variation in the power rate of the electric power supplied from the power distribution system 12A with respect to the power supply system 20. For example, EMS 24 can grasp the power rate of the power supply from the power distribution system 12A to the power supply system 20, by communicating with an electric power exchange through a transmission path, such as the Internet line or the like. The electric power exchange is the Japan Electric Power Exchange (JPEX), for example. In a case where the power rate of the electric power supplied from the power distribution system 12A to the power supply system 20 is low relative to a prescribed reference, for example, the EMS 24 may check the energy storage rate of the high voltage battery 41 through communication with the ECU 44. The power rate that is low relative to the prescribed reference may mean that the power rate is the prescribed reference or lower, or that the power rate is lower than the prescribed reference. In the case where the energy storage rate of the high voltage battery 41 is small relative to the predetermined reference, the EMS 24 may determine that the surplus power of the solar power generator 21 can be received, and may control the inverter device 43 via the ECU 44 to charge the high voltage battery 41 of the electric vehicle 40 with the electric power supplied from the power distribution system 12A via the power supply system 20. On the other hand, in the case where the power rate of the electric power supplied from the power distribution system 12A with respect to the power supply system 20 is not low relative to the prescribed reference, that is, when the power rate is high relative to the prescribed reference, the EMS 24 may check the energy storage rate of the high voltage battery 41 through communication with the ECU 44. Further, in the case where the energy storage rate of the high voltage battery 41 is large relative to the predetermined reference, the EMS 24 may determine that the high voltage battery 41 can be discharged, and may control the inverter device 43 via the ECU 44 to discharge the electric power of the high voltage battery 41 to the power supply system 20 of the house HM. Thus, the EMS 24 can charge the high voltage battery 41 with the electric power from the power distribution system 12A in the case where the power rate of the power grid 10 is relatively low, and can discharge the electric power of the high voltage battery 41 to the power supply system 20 in the case where the power rate of the power grid 10 is relatively high. For this reason, the EMS 24 can reduce the cost for using the electric power supplied from the power distribution system 12A to the power supply system 20.

Accordingly, the EMS 24 can absorb a power rate fluctuation of the electric power supplied from the power distribution system 12A to the power supply system 20, using the high voltage battery 41 of the electric vehicle 40, and can reduce the cost of the electric power consumed by the electric loads 22 of the power supply system 20.

In addition, the EMS 24 may discharge the electric power from the high voltage battery 41 of the electric vehicle 40 to the power supply system 20 of the house HM when the power supply from the power distribution system 12A to the power supply system 20 stops, that is, when a power failure occurs. In this case, the EMS 24 may switch the switch 23A to the open state in accordance with the occurrence of the power failure. The arrangement may be the same for the second example which will be described later. Accordingly, the EMS 24 can electrically disconnect the power distribution system 12A from the power supply system 20 at the time of power failure, and can prevent the power supply system 20 from being affected from a power grid related to the power failure (for example, effects of a short-circuit fault or the like). In particular, the EMS 24 may grasp the energy storage rate of the high voltage battery 41 through communication with the ECU 44 when the power failure occurs. In a case where the energy storage rate of the high voltage battery 41 is large relative to the predetermined reference, the EMS 24 may determine that the high voltage battery 41 can be discharged, and may control the inverter device 43 via the ECU 44 to discharge the electric power of the high voltage battery 41 to the power supply system 20 of the house HM. Hence, the EMS 24 can discharge the electric power of the high voltage battery 41 of the electric vehicle 40 and activate the electric load 22 of the house HM when the power failure occurs. For this reason, the resident of the house HM can continue to use the electric load 22 with the electric power of the high voltage battery 41 during at least a part of a time period of the power failure until the electric power is restored.

In addition, the EMS 24 may discharge the electric power from the high voltage battery 41 of the electric vehicle 40 to the power supply system 20 of the house HM only in a case where the electric power generated from the solar power generator 21 is small relative to the predetermined reference when the power failure occurs. In this case, the EMS 24 can reduce a decrease in the energy storage rate of the high voltage battery 41 when the power failure occurs, and can further extend the time period in which the resident of the house HM can continue to use the electric load 22 with the electric power of the high voltage battery 41.

Moreover, when the power failure occurs, the EMS 24 may control some of the switches 23E among the plurality of switches 23E to the state connecting the power lines PL23 and PL25, and control the remaining switches 23E to the state connecting the power lines PL24 and PL25, to discharge the electric power from the high voltage battery 41 of the electric vehicle 40 to the power supply system 20 of the house HM. In this case, when the electric power is supplied from the high voltage battery 41 of the electric vehicle 40 to the power supply system 20 of the house HM, the EMS 24 can restrict the supplying destinations of the electric power to some of the electric loads 22, and exclude the remaining electric loads 22 from the supplying destination. For this reason, the EMS 24 can reduce the decrease in the energy storage rate of the high voltage battery 41 when the power failure occurs, and can further extend the time period in which the resident of the house HM can continue to use the electric load 22 with the electric power of the high voltage battery 41. A part of the switches 23E to be controlled to the state connecting the power lines PL23 and PL25 when the power failure occurs may be fixed in advance, or may be varied by the setting operation performed by the resident of the residence HM. The arrangement may be the same for the second example which will be described later. In addition, as described above, the switch 23E may be provided on only some of the power lines PL25 among the plurality of power lines PL25, and the power lines PL25 not provided with the switch 23E may be connected to the power line PL23. In this case, when the power failure occurs and discharging from the high voltage battery 41 to the power supply system 20, the EMS 24 may be configured to control some of the switches 23E among the plurality of switches 23E to the state connecting the power lines PL23 and PL25 and control the remaining switches 23E to the state connecting the power lines PL24 and PL25, similar to the above, or configured to control all of the switches 23E to the state connecting the power lines PL24 and PL25. The arrangement may be the same for the second example which will be described later. In addition, the switches 23E to be controlled to the state connecting the power lines PL23 and PL25 when discharging the electric power from the high voltage battery 41 to the power supply system 20 may be the same or may be different between during a normal power supply and during the power failure. The arrangement may be the same for the second example which will be described later.

Accordingly, the EMS 24 can effectively utilize the high voltage battery 41 of the electric vehicle 40 as an emergency power source of the power supply system 20 of the house HM when the power failure occurs.

The charging and discharging cable 25 is provided such that the base end thereof is connected to the power line PL22 and extends out from the power line PL22. The connector that is electrically connectable to the charge and discharge port 45 of the electric vehicle 40 is provided on the tip end of the charging and discharging cable 25. The charging and discharging cable 25 functions as a power connection part PC for connecting the power supply system 20 and the electric vehicle 40 such that electric power is exchangeable therebetween, together with the charge and discharge port 45 provided on the electric vehicle 40. Accordingly, by connecting the connector on the tip end of the charging and discharging cable 25 to the charge and discharge port 45, it is possible to electrically connect the power supply system of the electric vehicle 40 to the power supply system 20 of the house HM. Specifically, as illustrated in FIG. 2 and FIG. 3, the charging and discharging cable 25 includes two power lines 25L and 25N that are provided so as to extend out from the two power lines PL22L and PL22N, respectively.

### «Configuration of Quick Charger»

The quick charger 30 is configured to enable conversion of an alternating current distributed from the power distribution system 12B into a direct current of a relatively high voltage, and outputting the direct current. The quick charger 30 includes a charging cable 31.

The charging cable 31 is provided so as to extend out from a main body of the quick charger 30. A connector that is electrically connectable to a charge port 46 of the electric vehicle 40 is provided on the tip end of the charging cable 31. Thus, by connecting the connector on the tip end of the charging cable 31 to the charge port 46, it is possible to connect the quick charger 30 and a DC power supply system of the electric vehicle 40. For this reason, the quick charger 30 can supply the electric power to the DC power supply system of the electric vehicle 40 via the charging cable 31, and quickly charge the high voltage battery 41 of the electric vehicle 40.

### «Configuration of Electric Vehicle»

The electric vehicle 40 includes the power lines PL41 to PL45, the high voltage battery 41, the electric motor 42, the inverter device 43, the ECU (Electronic Control Unit) 44, the charge and discharge port 45, and the charge port 46.

The power line PL41 is a DC power line connecting the high voltage battery 41 and the inverter device 43.

The power line PL42 is an AC power line connecting the inverter device 43 and the electric motor 42. Specifically, as illustrated in FIG. 2 and FIG. 3, the power line PL42 is a three-phase AC power line including a U-phase line PL42u, a V-phase line PL42v, and a W-phase line PL42w.

The power line PL43 is an AC power line connecting the electric motor 42 and the charge and discharge port 45. Specifically, the power line PL43 connects a neutral point 43NP of an armature 42A of the electric motor 42 and the charge and discharge port 45. The power line PL43 is connected to the power line 25L of the charging and discharging cable 25 in a state where the charge and discharge port 45 and the connector on the tip end of the charging and discharging cable 25 are connected.

The power line PL44 is a reference potential line connecting the charge and discharge port 45 and a DC link 43DC of the inverter device 43. The power line PL44 is connected to the power line 25N of the charging and discharging cable 25 in a state where the charge and discharge port 45 and the connector on the tip end of the charging and discharging cable 25 are connected.

For example, as illustrated in FIG. 2, the power line PL44 is connected to the power line PL22N of the power supply system 20 of the house HM, via the power line 25N of the charging and discharging cable 25, and a DC blocking capacitor 23F is provided on the power line PL22N. Accordingly, in the case where the electric power is exchanged between the power supply system 20 of the house HM and the electric vehicle 40, a DC component is eliminated from the alternating current at the neutral point 43NP of the armature 42A generated between the power line PL44 and the armature 42A, and thus, it is possible to generate a single-phase AC voltage that does not include the DC component. In addition, because the DC blocking capacitor 23F is provided in the power supply system 20 of the house HM, it is possible to reduce an increase in the cost and weight of the electric vehicle 40.

Moreover, as illustrated in FIG. 3, the power line PL44 may be connected to an intermediate point between balanced smoothing capacitors 43c1 and 43c2 of the DC link 43DC. Thus, the smoothing capacitors 43c1 and 43c2 can perform the same functions as the DC blocking capacitor 23F. For this reason, it is possible to reduce an increase in the cost and weight of the electric vehicle 40, and to reduce the cost of the power supply system 20 of the house HM and the power supply system of the electric vehicle 40 as a whole.

The power line PL45 is a DC power line connecting the high voltage battery 41 and the charge port 46.

The high voltage battery 41 is a storage battery having a relatively high output voltage (for example, several hundred volts). The high voltage battery 41 is a liquid type lithium ion battery, for example. In addition, the high voltage battery 41 may be an all-solid-state battery. The high voltage battery 41 is provided with sensors capable of measuring various states of the high voltage battery 41, such as current, voltage, temperature, or the like. Outputs of the sensors provided on the high voltage battery 41 are captured by the ECU 44 via an in-vehicle network, such as a one-to-one communication line, a controller area network (CAN), an in-vehicle Ethernet, or the like.

The electric motor 42 is the motor that drives the driving wheels of the electric vehicle 40. The electric motor 42 is driven by the three-phase alternating current supplied from the inverter device 43. Specifically, as illustrated in FIG. 2 and FIG. 3, the electric motor 42 includes the armature 42A which is an example of a stator, and the armature 42A includes a U-phase winding 42u, a V-phase winding 42v, and a W-phase winding 42w which are connected by a Y-connection.

The inverter device 43 converts the direct current supplied from the high voltage battery 41 via the power line PL41 into a three-phase alternating current having a predetermined voltage and a predetermined frequency, and outputs the three-phase alternating current to the power line PL42, thereby driving the electric motor 42. Specifically, as illustrated in FIG. 2 and FIG. 3, the inverter device 43 includes a smoothing circuit 43A, and an inverter circuit 43B. The inverter device 43 is provided with sensors capable of measuring various states of the inverter device 43, such as the current, voltage, temperature, or the like. Outputs of the sensors provided on the inverter device 43 are captured by the ECU 44 via the in-vehicle network, such as the one-to-one communication line, the controller area network (CAN), the in-vehicle Ethernet, or the like.

The smoothing circuit 43A suppresses and smoothens pulsations of the direct current output from the high voltage battery 41 and the direct current output from the inverter circuit 43B. The smoothing circuit 43A includes a smoothing capacitor 43c of the DC link 43DC. For example, as illustrated in FIG. 2, the smoothing capacitor 43c is provided on a power line between a positive line 43P and a negative line 43N of the DC link 43DC. The smoothing capacitor 43c may be configured by a single capacitor, or may be configured by a plurality of capacitors. For example, as illustrated in FIG. 3, the smoothing capacitor 43c is configured by a plurality of (in this example, two) smoothing capacitors 43c1 and 43c2 connected in series between the positive line 43P and the negative line 43N. Thus, as described above, one end of the power line PL44 is connected to the intermediate point between two mutually adjacent smoothing capacitors that are connected in series among the plurality of smoothing capacitors, such that the same functions as the DC blocking capacitor can be obtained. Further, even if a short-circuit failure occurs in some of the plurality of capacitors connected in series between the positive line 43P and the negative line 43N, for example, the smoothing capacitor 43c, which is an example of a series connection body of the plurality of capacitors, can avoid a fatal failure. For this reason, the inverter device 43 can continue operating although there is a possibility that some kind of restriction may be imposed.

The positive line 43P and the negative line 43N of the DC link 43DC are connected to one end of the inverter circuit 43B, and the U-phase line PL42u, the V-phase line PL42v, and the W-phase line PL42w of the three- phase AC power line PL42 are connected to the other end of the inverter circuit 43B.

For example, as illustrated in FIG. 2 and FIG. 3, the inverter circuit 43B includes six semiconductor switches 43sw. The semiconductor switch 43sw is an insulated gate bipolar transistor (IGBT), a metal-oxide-semiconductor field effect transistor (MOSFET), a high electron mobility transistor (HEMT), or the like, for example. The semiconductor switch 43sw is made of, for example, Si as a main material. The semiconductor switch 43sw may be formed of a wide bandgap semiconductor material as a main material thereof. The wide bandgap semiconducting material is silicon carbide (Sic), gallium nitride (GaN), gallium oxide (Ga₂O₃), carbon (diamond: C), or the like, for example. Specifically, the inverter circuit 43B includes a bridge circuit in which three switch legs are connected in parallel between the positive line 43P and the negative line 43N, where each switch leg has two semiconductor switches 43sw forming upper and lower arms and connected in series. Moreover, the U-phase line PL42u, the V-phase line PL42v, and the W-phase line PL42w are drawn out from the intermediate point of the three pairs of upper and lower arms of the bridge circuit, and are connected to the U-phase winding 42u, the V-phase winding 42v, and the W-phase winding 42w of the armature 42A, respectively. Further, a free wheeling diode 43d may be connected in parallel to each of the six semiconductor switches 43sw.

The inverter device 43 is not limited to a two-level inverter device, and may be a multi-level inverter device having three or more levels. The arrangement may be the same for the second example which will be described later. In this case, in order to divide the voltage of the DC link 43DC of the inverter device 43 into a plurality of voltages (two voltages in the case of three levels), a plurality of (two in the case of three levels) voltage-dividing capacitors are arranged in series between the positive line 43P and the negative line 43N. For example, in the case where the multi-level inverter device 43 is employed, the power line PL44 may be connected to an intermediate point between the two capacitors arranged in series between the positive line 43P and the negative line 43N of the inverter device 43. In this case, it is possible to obtain the same functions and effects as when the power line PL44 is connected to the intermediate point between the smoothing capacitors 43c1 and 43c2 (refer to FIG. 3).

In an operating state of the electric vehicle 40, the inverter circuit 43B converts the direct current of the DC link 43DC into an alternating current and outputs the alternating current to the power line PL42, or converts the alternating current of the power line PL42 into a direct current and outputs the direct current to the DC link 43DC, by the switching operation of the semiconductor switch 43sw under the control of the ECU 44.

For example, in a traveling state of the electric vehicle 40, the inverter circuit 43B converts the direct current supplied from the DC link 43DC into a three-phase alternating current having a predetermined voltage and a predetermined frequency, and outputs the three-phase alternating current to the electric motor 42. Thus, the inverter device 43 can drive the electric motor 42 and cause the electric vehicle 40 to travel. When the electric vehicle 40 decelerates, the inverter circuit 43B converts the AC power generated by the armature 42A into DC power and outputs the DC power to the DC link 43DC, according to a regenerative operation of the electric motor 42. Accordingly, the inverter device 43 can output a kinetic energy that is generated when the electric vehicle 40 travels to the DC link 43DC as an electrical energy (regenerative energy) to charge the high voltage battery 41, and also cause the electric vehicle 40 to generate a braking force by regeneration.

In addition, in a stopped state of the electric vehicle 40, the inverter circuit 43B converts the direct current of the DC link 43DC into the alternating current, and supplies the alternating current to the power supply system 20 of the house HM via the neutral point 43NP of the armature 42A, the power line PL42, and the charging and discharging cable 25. The stopped state of the electric vehicle 40 refers to a state where the electric vehicle 40 cannot travel, and is a state where an accessory power source of the electric vehicle 40 is off (ACC-OFF) or a state where an ignition power source of the electric vehicle 40 is off (IG-OFF), for example. Hence, the inverter device 43 can convert the output of the high voltage battery 41 into the alternating current and supply the alternating current to the power supply system 20 of the house HM, and as a result, the power supply system 20 of the house HM can activate the electric load 22 by the AC power supplied from the electric vehicle 40. In addition, when the electric vehicle 40 is in the stopped state, the inverter circuit 43B converts the alternating current supplied via the charging and discharging cable 25, the power line PL42, and the neutral point 43NP of the armature 42A into the direct current, and outputs the direct current to the DC link 43DC. Thus, the inverter device 43 can charge the high voltage battery 41 with the AC power supplied from the power supply system 20 of the house HM.

Accordingly, in the present example, the electrical power system 1 can charge the high voltage battery 41 with the AC power supplied from the power supply system 20 of the house HM, and can discharge the electric power of the high voltage battery 41 from the electric vehicle 40 to the power supply system 20 of the house HM, using the inverter device 43. For this reason, it is not necessary to provide an additional power converter for performing power conversion between the direct current of the high voltage battery 41 and the alternating current of the power supply system 20 of the house HM, thereby making it is possible to simplify the configuration related to the exchange of electric power between the power supply system 20 of the house HM and the electric vehicle 40. In addition, because installation of an additional power converter is unnecessary, it is possible to reduce an initial investment related to the exchange of electric power between the power supply system 20 of the house HM and the electric vehicle 40.

The ECU 44 is a controller of the electric vehicle 40. One or more ECUs 44 may be provided in the electric vehicle 40. The arrangement may be the same for the second example which will be described later.

Functions of the ECU 44 may be implemented by arbitrary hardware or a combination of arbitrary hardware and software. For example, the ECU 44 may be mainly configured by a computer including a CPU, a memory device, an auxiliary storage device, and an interface device. Thus, the ECU 44 can implement various functions by loading a program installed in the auxiliary storage device into the memory device and causing the CPU to execute the program. The memory device is an SRAM, for example. The auxiliary storage device is an EEPROM, a flash memory, or the like, for example. The interface device includes an external interface to be connected to a recording medium, or a communication interface for communicating with the outside, for example. Hence, the ECU 44 can install the program and data required by a process from the recording medium into the auxiliary storage device via the external interface, for example. In addition, the ECU 44 can communicate with various devices (for example, the high voltage battery 41, the inverter device 43, or the like) of the electric vehicle 40 or external devices (for example, the EMS 24) outside the electric vehicle 40 via the communication interface. Moreover, the ECU 44 can download the program and data required by the process from the external device using the communication interface, and install the program and data into the auxiliary storage device, for example.

For example, in the operating state of the electric vehicle 40, the ECU 44 outputs a control command to the inverter device 43 to control the driving of the electric motor 42 via the inverter device 43. The operating state of the electric vehicle 40 refers to a state where the electric vehicle 40 can travel, and is a state where the ignition power source of the electric vehicle 40 is on (IG-ON), for example. In this state, the ECU 44 may control the driving of the electric motor 42 in response to an operation of a steering wheel, an accelerator pedal, a brake pedal, or the like by a driver of the electric vehicle 40, or may control the driving of the electric motor 42 in response to a higher-level command corresponding to a so-called autonomous driving. The arrangement may be the same for the second example which will be described later.

Further, in the stopped state of the electric vehicle 40, the ECU 44 controls the inverter device 43 under the control of the EMS 24 to convert the alternating current of the power lines PL43 and PL42 into the direct current and output the direct current to the DC link 43DC. Accordingly, the ECU 44 can charge the high voltage battery 41 with the AC power supplied from the power supply system 20 of the house HM in response to a command from the EMS 24.

Moreover, in the stopped state of the electric vehicle 40, the ECU 44 controls the inverter device 43 under the control of the EMS 24 to convert the direct current of the DC link 43DC into the alternating current and output the alternating current to the power lines PL42 and PL43. Accordingly, the ECU 44 can discharge the electric power of the high voltage battery 41 to the power supply system 20 of the house HM in response to the command from the EMS 24.

In addition, the ECU 44 transmits information of the sensors provided on the high voltage battery 41 and the sensors provided on the inverter device 43 to the EMS 24. Thus, the EMS 24 located in the higher level can grasp the states of the high voltage battery 41 and the inverter device 43.

The charge and discharge port 45 is provided on a body surface of the electric vehicle 40, and is configured to be connectable to the connector on the tip end of the charging and discharging cable 25 extending from the house HM. For example, the charge and discharge port 45 is normally covered with a lid member or the like which can open and close. When the electric vehicle 40 is parked at the house HM and the charge and discharge port 45 is to be connected to the connector of the charging and discharging cable 25, the lid member is opened manually or automatically by an operation of the user of the electric vehicle 40 or the resident of the house HM, thereby exposing the charge and discharge port 45 to the outside.

The charge port 46 is provided on the body surface of the electric vehicle 40, and is configured to be connectable to the connector on the tip end of the charging cable 31 extending from the quick charger 30, similar to the charge and discharge port 45. For example, the charge port 46 is normally covered with a lid member or the like which can open and close. When the electric vehicle 40 is parked near the quick charger 30 and the charge port 46 is to be connected to the connector of the charging cable 31, the lid member is opened manually or automatically by an operation of the user, thereby exposing the charge port 46 to the outside.

The charge and discharge port 45 and the charge port 46 may be provided adjacent to each other and arranged to be covered by the same lid member, or may be arranged at different positions to be covered by different lid members.

### <Operation>

Next, operations of the electrical power system, the power supply apparatus, the power converter, and the controller according to the present example will be described.

In the present embodiment, the electrical power system includes a storage battery, an electric motor, a power converter, a first power line, a power supply system, and a power connection part. The electrical power system is the electrical power system 1 described above, for example. The storage battery is the high voltage battery 41 described above, for example. The electric motor is the electric motor 42 described above, for example. The power converter is the inverter device 43 described above, for example. The first power line is the power line PL43 described above, for example. The power supply system is the power supply system 20 described above, for example. The power connection part is the power connection part PC described above, for example. Specifically, the storage battery and the electric motor are provided in a vehicle.

The vehicle is the electric vehicle 40 described above, for example. The power converter is electrically connected to both the storage battery and the electric motor in the vehicle, and converts an output of the storage battery into an alternating current to drive the electric motor. The first power line extends from a neutral point of an armature of the electric motor in the vehicle. The neutral point of the armature is the neutral point 42NP of the armature 42A described above, for example. In addition, the power supply system is provided in a house or a facility. The house or the facility is the house HM described above, for example. Moreover, the power connection part connects the power supply system and the first power line such that electric power is exchangeable therebetween. Further, the storage battery can be charged with the electric power supplied from the power supply system via the power converter, the neutral point, the first power line, and the power connection part, and can discharge the electric power to the power supply system.

Specifically, the power connection part may include a charge and discharge port provided on a tip end of the first power line in the vehicle, and a charging and discharging cable provided to extend from the power supply system and having a tip end electrically connectable to the charge and discharge port. The charge and discharge port is the charge and discharge port 45 described above, for example. The charging and discharging cable is the charging and discharging cable 25 described above, for example.

The electrical power system can cause an existing power converter provided in the vehicle to perform the conversion between the direct current which is the output of the storage battery and the alternating current used in the power supply system of the house or the facility when exchanging electric power between the vehicle provided with the storage battery and the power supply system of the house or the like. For this reason, it is not necessary to provide an additional device for performing the conversion between the alternating current and the direct current, and the electrical power system can exchange the electric power between the vehicle and the house or the like using a simple configuration.

Moreover, in the present embodiment, the electrical power system may include a power supply apparatus. The power supply apparatus is the power supply apparatus 23 described above, for example. Specifically, the power supply apparatus may be provided in the power supply system, and may be electrically connected to each of an electric load in the house or the facility, the power connection part (for example, the charging and discharging cable), and a predetermined power source. The electric load is the electric load 22 described above, for example. The predetermined power source is the power distribution system 12A of the power grid 10 or the solar power generator 21, for example. Further, in the electrical power system, the power supply apparatus may supply the alternating current of the predetermined power source to the first power line via the power connection part (for example, the charging and discharging cable), and the power converter may convert the alternating current supplied to the first power line into the direct current and output the direct current to the storage battery, thereby charging the storage battery with the electric power of the predetermined power source. In the electrical power system, the power converter may convert the output of the storage battery into the alternating current and output the alternating current to the armature side, and supply the alternating current to the power supply system via the neutral point, the first power line, and the power connection part (for example, the charging and discharging cable), and the power supply apparatus may supply the electric power from the storage battery to the electric load, thereby discharging the electric power of the storage battery to the electric load.

In addition, in the present embodiment, the power supply apparatus is provided in the house or the facility, and can exchange the electric power with the vehicle via the power connection part (for example, the charging and discharging cable connectable to the charge and discharge port connected to the tip end of the first power line of the vehicle), where the vehicle includes the storage battery, the electric motor, the power converter electrically connected to both the storage battery and the electric motor and configured to convert the output of the storage battery into the alternating current and drive the electric motor, and the first power line extending from the neutral point of the armature of the electric motor. Specifically, the power supply apparatus is electrically connected to each of the electric load in the house or facility, the power connection part (for example, the charging and discharging cable), and the predetermined power source. Further, the power supply apparatus supplies the alternating current of the predetermined power source to the first power line via the power connection part (for example, the charging and discharging cable), thereby charging the storage battery with the electric power of the predetermined power source. The power supply apparatus supplies the alternating current supplied from the first power line to the electric load via the power connection part (for example, the charging and discharging cable), thereby discharging the electric power of the storage battery to the electric load.

Moreover, in the present embodiment, the power converter is provided in the vehicle including the storage battery, the electric motor, and the first power line extending from the neutral point of the armature of the electric motor, and the power converter is electrically connected to both the storage battery and the electric motor, and converts the direct current of the storage battery into the alternating current to drive the electric motor. The power converter may convert the alternating current supplied from the predetermined power source outside the vehicle to the power line via the power connection part (for example, the charging and discharging cable connected to the charge and discharge port that is connected to the tip end of the power line of the vehicle) into the direct current and output the direct current to the storage battery, thereby charging the storage battery with the electric power of the predetermined power source. The power converter may convert the output of the storage battery into the alternating current, output the alternating current to the armature side, and supply the alternating current to the electric load in the house or the facility via the neutral point of the armature, the power line, and the power connection part (for example, the charging and discharging cable), thereby discharging the electric power of the storage battery to the electric load.

Further, in the present embodiment, the controller controls the electrical power system including the storage battery provided in the vehicle, the electric motor provided in the vehicle, the power converter electrically connected to both the storage battery and the electric motor and configured to convert the output of the storage battery into the alternating current, the power line provided in the vehicle and extending from the neutral point of the armature of the electric motor, the power connection part that connects the power supply system and the power line of the vehicle such that the electric power can be exchanged therebetween, the power supply system provided in the house or the facility, the power connection part (for example, the charging and discharging cable provided to extend from the power supply system and having the tip end electrically connectable to the charge and discharge port that is connected to the tip of the power line of the vehicle), and the power supply apparatus provided in the power supply system and electrically connected to each of the electric load in the house or the facility, the power connection part (for example, the charging and discharging cable), and the predetermined power source. The controller is the EMS 24, for example. Specifically, the controller may control the power supply apparatus to supply the alternating current of the predetermined power source to the power line via the power connection part (for example, the charging and discharging cable), and control the power converter to convert the alternating current supplied to the power line into the direct current and output the direct current to the storage battery, thereby charging the storage battery with the electric power of the predetermined power source. In addition, the controller may control the power converter to convert the output of the storage battery into the alternating current and output the alternating current to the armature side, and supply the alternating current to the power supply system via the neutral point of the armature, the power line, and the power connection portion (for example, the charging and discharging cable), and control the power supply apparatus to supply the electric power thereof to the electric load, thereby discharging the electric power of the storage battery to the electric load.

Accordingly, the electrical power system or the like can charge the storage battery of the vehicle with the electric power of the predetermined power source of the house or the like, and can discharge the electric power of the storage battery of the vehicle to the electric load in the house or the facility to activate the electric load.

Further, in the present embodiment, the power supply system may be electrically connected to an AC power distribution system that distributes an AC power of a power grid to the house or the facility. The power grid is the power grid 10 described above, for example. The AC power distribution system is the power distribution system 12A described above, for example. A first switch, which can electrically open and close between the AC power distribution system and the power supply system, may be provided. The first switch is the switch 23A, for example.

Accordingly, in the case where the electric power is discharged from the storage battery of the vehicle to the power supply system of the house or the like via the power converter, for example, the electrical power system or the like can prohibit the interconnection between the power supply system on the vehicle side and the power grid, by setting the first switch to the open state. For this reason, even in a case where it is difficult for the power converter to satisfy the interconnection requirements with respect to the power grid, for example, it is possible to achieve the electric power exchange between the vehicle and the power supply system of the house or the like, using the power converter.

Moreover, in the present embodiment, the electrical power system may include a filter capacitor that eliminates the high-frequency component of the output current when the power converter converts the output of the storage battery into the alternating current. The filter capacitor is the filter capacitor 23C described above, for example.

Thus, the electrical power system or the like can eliminate the high-frequency component of the current output from the power converter to the power supply system of the house or the like.

In addition, in the present embodiment, the filter capacitor may be provided in the power supply system.

Hence, the electrical power system or the like can reduce an increase in the weight and cost of the vehicle when achieving the electric power exchange between the vehicle and the house or the like.

Moreover, in the present embodiment, the power supply system may include a plurality of load systems that supply electric power to the electric loads in the house or the facility. The plurality of load systems are the plurality of power lines PL25 described above, for example. At least some of the plurality of load systems may be provided with a second switch configured to switch between a state where the load system is electrically connected to only one of the charging cable and the predetermined power source and a state where the load system is electrically connected to only the other of the charging cable and the predetermined power source. The second switch is the switch 23E, for example.

Accordingly, in the case where the storage battery of the vehicle is discharged to the power supply system of the house or the like, for example, the electrical power system or the like can set the second switch to a state where a target load system is connected to only the predetermined power source, and restrict the power supply from the storage battery of the vehicle to only some of the plurality of load systems. For this reason, even in the case where the electric power supplied from the storage battery cannot cover the electric power to be supplied to all of the plurality of load systems, the electrical power system or the like can supply the electric power of the high voltage battery 41 to some of the load systems and supply the electric power from the predetermined power source to the remaining load systems. In addition, the second switch can selectively switch the connecting destination of the load system between the storage battery side and the predetermined power source side. For this reason, in the case where the predetermined power source is the electrical power system, the electrical power system or the like can avoid the vehicle from being interconnected to the electrical power system, while supplying the electric power from the electrical power system to the remaining load systems.

Moreover, in the present embodiment, a DC blocking capacitor, which functions so as not to include a DC component (offset component) at the neutral point of the armature, may be provided. The DC blocking capacitor is the DC blocking capacitor 23F described above, for example. Further, by connecting the power line PL44 to the intermediate point between the balanced smoothing capacitors 43c1 and 43c2, it is possible to obtain the same effects as the DC blocking capacitor.

Accordingly, the electrical power system or the like can generate a single-phase AC voltage that does not include a DC component at the neutral point of the armature when the electric power is exchanged between the vehicle and the house or the like.

Moreover, in the present embodiment, the DC blocking capacitor may be provided in the power supply system. The DC blocking capacitor is the DC blocking capacitor 23F described above, for example.

Thus, the electrical power system or the like can reduce an increase in the weight and cost of the vehicle when achieving the electric power exchange between the vehicle and the house or the like.

Further, in the present embodiment, the power converter may include a plurality of smoothing capacitors connected in series between a positive-side line and a negative-side line of a DC link. The DC link is the DC link 43DC described above, for example. The positive-side line and the negative-side line are the positive line 43P and the negative line 43N described above, respectively, for example. The plurality of smoothing capacitors are the smoothing capacitors 43c1 and 43c2, for example. In addition, a second power line having one end thereof connected to an intermediate point between two mutually adjacent smoothing capacitors among the plurality of balanced smoothing capacitors, and the other end thereof connected to the charge and discharge port, may be provided, and the second power line may be connected to the power supply system via the charging and discharging cable. The second power line is the power line PL44 of FIG. 3 described above, for example.

Hence, the circuit configuration including the two smoothing capacitors and the second power line can perform the same functions as the DC blocking capacitor. For this reason, the electrical power system or the like can reduce an increase in the weight and cost of the vehicle when realizing the electric power exchange between the vehicle and the house or the like.

In addition, in the present embodiment, the power supply system may include a renewable energy derived power source. The renewable energy derived power source is the solar power generator 21 described above, for example.

In a case where the output of the renewable energy derived power source is relatively large, for example, the electrical power system or the like can charge the storage battery of the vehicle with the electrical power of the renewable energy derived power source, and in a case where the output of the renewable energy derived power source is relatively small, the electrical power system or the like can discharge the electric power of the storage battery to the power supply system of the house or the like. For this reason, the electrical power system or the like can cause the storage battery of the vehicle to absorb the output fluctuation of the renewable energy derived power source.

Moreover, in the present embodiment, the power supply system is connected to the power grid. The power grid is the power grid 10 described above, for example. The storage battery may be charged with the electric power supplied from the power grid via the power supply system in a case where the power rate of the power grid is relatively low, and may discharge the electric power to the power supply system in a case where the power rate of the power grid is relatively high.

Thus, the electrical power system or the like can absorb the power rate fluctuation of the electrical power system caused by the dynamic pricing, using the storage battery of the vehicle, and can reduce the cost of the electric power consumed by the electric load in the electrical power system of the house or the facility.

### [Second Example of Electrical Power System]

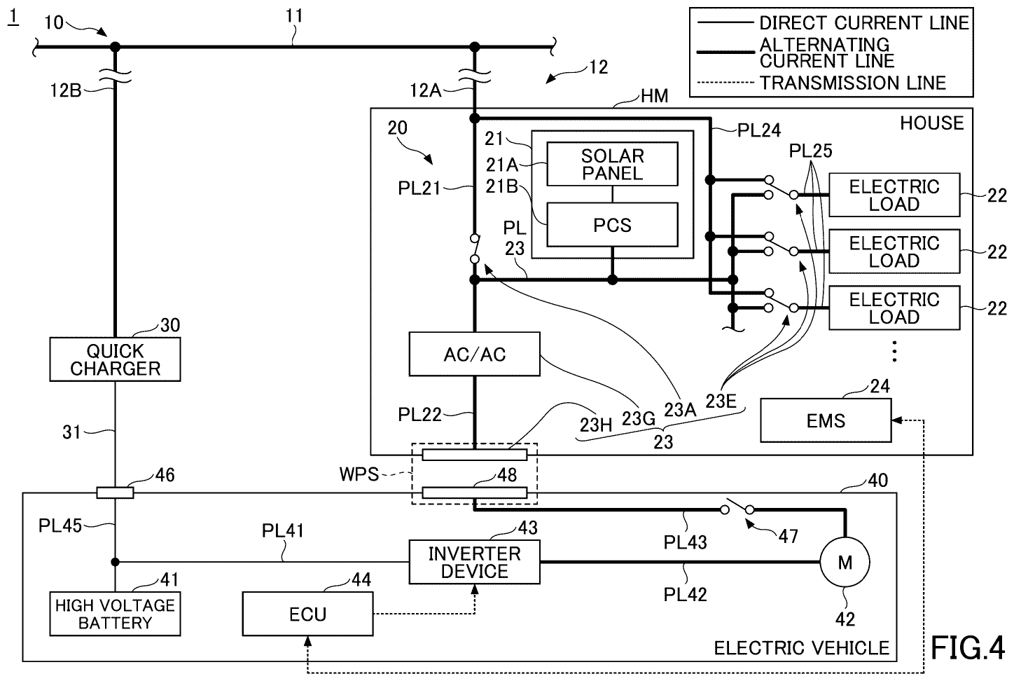

An overview of a second example of the electrical power system 1 according to the present embodiment will be described with reference to FIG. 4 through FIG. 6.

Hereinafter, the same or corresponding constituent elements as those of the first example described above are designated by the same reference numerals, and the constituent elements that are different from those of the first example described above will mainly be described, and a description of the same or corresponding constituent elements as those of the first example described above may be omitted.

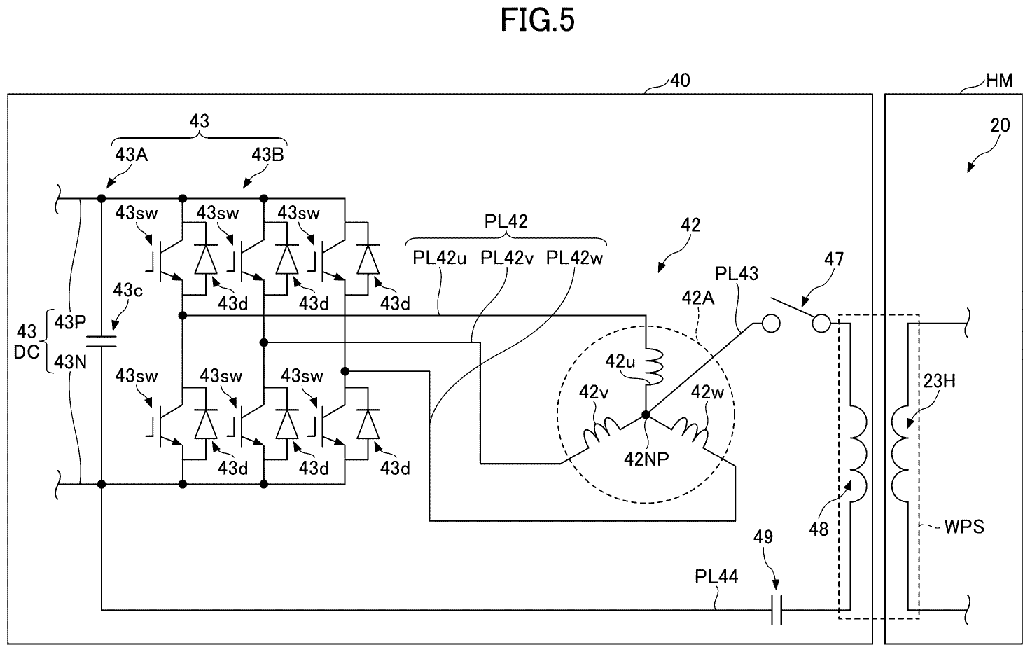

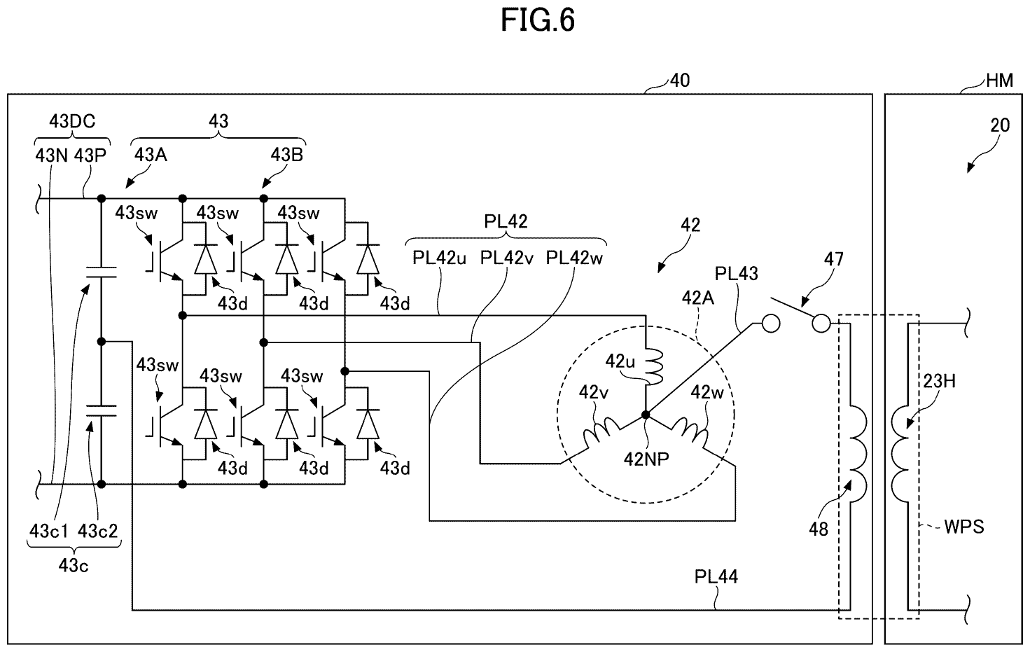

FIG. 4 is a diagram illustrating an example of the electrical power system 1. FIG. 5 is a diagram illustrating a third example of the circuit configuration related to the exchange of electric power between the power supply system 20 of the house HM and the electric vehicle 40. FIG. 6 is a diagram illustrating a fourth example of the circuit configuration related to the exchange of electric power between the power supply system 20 of the house HM and the electric vehicle 40.

For the sake of convenience, FIG. 4 illustrates a state where the electric vehicle 40 is electrically connected to both the power supply system 20 of the house HM and the quick charger 30, but normally, the power supply system of the electric vehicle 40 is electrically connected to only one of the power supply system 20 of the house HM and the quick charger 30.

### <Overview of Electrical Power System>

An overview of the electrical power system 1 will be described with reference to FIG. 1.

As illustrated in FIG. 4, the electrical power system 1 according to the present example includes the power grid 10, the power supply system 20, the quick charger 30, and the electric vehicle 40, similar to the first example described above.

The power grid 10 generates, transmits, and converts the electric power, and distributes the electric power to the customer, similar to the first example described above.

The power supply system 20 is provided in the house HM, exchanges the electric power with the outside of the house HM, such as the power grid 10, the electric vehicle 40, or the like, and distributes the electric power in the house HM, similar to the first example described above.

The quick charger 30 is electrically connected to the electric vehicle 40 via the charging cable 31, and performs the so-called quick charging of the high voltage battery 41 of the electric vehicle 40 by supplying the DC power of a relatively high voltage, similar to the first example described above.

The electric vehicle 40 is provided with the high voltage battery 41, and drives the electric motor 42, which is an example of a motor, with the electric power of the high voltage battery 41, thereby driving wheels by the power of the electric motor 42 to cause the electric vehicle 40 to travel, similar to the first example described above. The electric vehicle 40 can be electrically connected to the power supply system 20 of the house HM via a bidirectional contactless power supply device WPS. Accordingly, the electric vehicle 40 can convert the alternating current supplied from the power supply system 20 into the direct current to charge the high voltage battery 41, or can convert the DC power of the high voltage battery 41 into the AC power to discharge the AC power to the power supply system 20 of the house HM.

The electric vehicle 40 may be parked in the parking space adjacent to the house HM, similar to the first example described above. The electric vehicle 40 is a private car used by the resident of the house HM, for example. Further, the electric vehicle 40 may be a car sharing vehicle deployed in the parking space adjacent to the house HM. In a state where the electric vehicle 40 is parked in the parking space of the house HM, a positional relationship is obtainable such that a contactless power transmission can be performed between a power transmitting and receiving device 48 provided in the electric vehicle 40 and a power transmitting and receiving device 23H provided in the parking space of the house HM.

Accordingly, the electrical power system 1 can exchange the electric power between the power supply system 20 of the house HM and the high voltage battery 41 of the electric vehicle 40 via the power transmitting and receiving device 23H and the power transmitting and receiving device 48. Hereinafter, in the present specification, a case where the electric vehicle 40 is parked in the parking space of the house HM will be mainly described.

### <Configuration of Electrical Power System>

Next, the configuration of the electrical power system 1 will be described with reference to FIG. 5 and FIG. 6, in addition to FIG. 4.

### «Configuration of Power Grid»

The power grid includes the power transmission system 11 and the power distribution system 12, similar to the first example described above.

The power distribution system 12 includes the power distribution systems 12A and 12B, similar to the first example.

«Configuration of Power Supply System of House»The power supply system 20 of the house HM includes the power lines PL21 to PL25, the solar power generator 21, the electric loads 22, the power supply apparatus 23, and the EMS 24, similar to the first example described above.

The power lines PL21 to PL25 are AC power lines, similar to the first example described above. Similar to the first example described above, the power line PL21 has one end thereof connected to the power distribution system 12A, and the other end thereof connected to the power line PL22 and the power line PL23. The power line PL22 has one end thereof connected to the power transmitting and receiving device 23H, and the other end thereof connected to the power line PL21 and the power line PL23. Similar to the first example described above, the power line PL23 has one end thereof connected to the power line PL21 and the power line PL22, and the other end thereof connected to the plurality of power lines PL25 via the plurality of switches 23E. Similar to the first example described above, the power line PL24 has one end thereof connected to the power distribution system 12A, and the other end thereof connected to the plurality of power lines PL25 via the plurality of switches 23E. Each power line PL25 supplies the electric power supplied from one of the power lines PL23 and PL24 to the electric load 22 via the switch 23E, similar to the first example described above.

The solar power generator 21 includes the solar panel 21A and the power conditioning system 21B, similar to the first example described above.

The solar panel 21A converts the solar energy into the electrical energy and outputs the electrical energy, similar to the first example described above. The PCS 21B converts the DC output of the solar panel 21A into the AC output, and outputs the AC output to the power line PL23, similar to the first example described above.

For example, the solar power generator 21 can supply the electric power from the power line PL23 to the electric load 22 via the power line PL25, similar to the first example described above. Further, the solar power generator 21 can be interconnected with the power grid 10 from the power line PL23 via the power line PL21, and supply the electric power to the power grid 10, similar to the first example described above. Further, the solar power generator 21 can supply the electric power from the power line PL23 to the electric vehicle 40 via the power line PL22 and the contactless power supply device WPS, similar to the first example described above.

The electric load 22 is activated by the alternating current of the power line PL25, similar to the first example described above.

The power supply apparatus 23 is electrically connected to the power distribution system 12A, the contactless power supply device WPS, and the electric load 22 via the power lines PL21 to PL25, exchanges the electric power inside the power supply system 20, and exchanges the electric power between the power supply system 20 and the outside. The power supply apparatus 23 includes the switch 23A, a power converter 23G, a power transmitting and receiving device 23H, and the plurality of switches 23E.

The switch 23A is provided on the power line PL21, similar to the first example described above. The switch 23A is configured to be able to electrically open and close the power line EMS 24 under the control of the PL21, similar to the first example described above. Accordingly, the power supply system 20 of the house HM can switch between the state where the power distribution system 12A and the power lines PL22 and PL23 are electrically connected and a state where the power distribution system 12A and the power lines PL22 and PL23 are electrically disconnected.

The power converter 23G is provided on the power line PL22, and exchanges AC power between the side of the power line PL22 closer to the power transmitting and receiving device 23H and the side of the power line PL22 closer to the power lines PL21 and PL23. The power converter 23G functions as a frequency converter that exchanges the electric power between an AC side of the power transmitting and receiving device 23H that may have a high frequency due to the contactless power transmission by the contactless power supply device WPS and an AC side of the power line PL21 having a commercial frequency supplied from the power distribution system 12A. In addition, the power converter 23G may be a certified equipment which satisfies the interconnection requirements with respect to the power grid 10. Thus, the power converter 23G can output the AC power supplied from the electric vehicle 40 via the contactless power supply device WPS, to the power grid 10 via the power lines PL22 and PL21.

The power transmitting and receiving device 23H is an interface, that is provided on the tip end of the power line PL22, and is configured to contactlessly exchange the electric power with the electric vehicle 40 under the control of the EMS 24. The power transmitting and receiving device 23H forms the contactless power supply device WPS together with the power transmitting and receiving device 48 that is provided in the electric vehicle 40. Accordingly, the resident of the house HM or the user of the electric vehicle 40, for example, can achieve a state where the electric power can be exchanged between the power supply system 20 of the house HM and the electric vehicle 40 without performing an operation of connecting a cable or the like between the power supply system 20 of the house HM and the electric vehicle 40. For this reason, the contactless power supply device WPS can provide improved convenience to the resident of the house HM and the user of the electric vehicle 40.

The contactless power supply device WPS can bidirectionally exchange the electric power in a contactless (wireless) manner with one of the power transmitting and receiving device 23H and the power transmitting and receiving device 48 serving as a power transmission side and the other of the power transmitting and receiving device 23H and the power transmitting and receiving device 48 serving as a power reception side. The contactless power supply device WPS may achieve the contactless power exchange between the power transmitting and receiving device 23H and the power transmitting and receiving device 48 by an arbitrary method that is known. For example, the contactless power supply device WPS is a transformer in which the electric power is transmitted from a primary side (the power transmission side) to a secondary side (the power reception side) by electromagnetic induction according to a magnetic coupling between coils of the power transmitting and receiving device 23H and the power transmitting and receiving device 48. In addition, the contactless power supply device WPS may transmit the electric power from the coil on the power transmission side to the coil on the power reception side of the power transmitting and receiving device 23H and the power transmitting and receiving device 48 by magnetic resonance. In this case, it is possible to increase a distance over which the electric power can be transmitted between the power transmitting and receiving device 23H and the power transmitting and receiving device 48, when compared to the normal electric power transmission by the electromagnetic induction. For this reason, restrictions on the positional relationship between the power transmitting and receiving device 23H and the power transmitting and receiving device 48 can be relatively relaxed, and as a result, it is possible to provide improved convenience to the resident of the house HM or the user of the electric vehicle 40.

The switch 23E is provided for each of the plurality of power lines PL25, similar to the first example described above. The switch 23E is configured to switch between the state where the power line PL25 is electrically connected to the power line PL23 and the state where the power line PL25 is electrically connected to the power line PL24 under the control of the EMS 24. Thus, in the case where the electric power is supplied from the high voltage battery 41 of the electric vehicle 40 to the power supply system 20, the switch 23E can selectively switch between the state where the electric power from the high voltage battery 41 is supplied to the electric load 22 via the power lines PL22 and PL23, and the state where the electric power from the power distribution system 12A is supplied to the electric load 22 via the power line PL24, under the assumption that the switch 23A is in the open state.

The EMS 24 performs the control related to the power supply system 20 of the house HM, similar to the first example described above.

In the present example, the EMS 24 performs the control related to the exchange of the electric power between the power supply system 20 of the house HM and the electric vehicle 40 in cooperation with the ECU 44 of the electric vehicle 40 by the two-way communication with the ECU 44, similar to the first example described above.

For example, in a case where the power supply system 20 of the house HM is to supply the electric power to the electric vehicle 40, the EMS 24 controls the power converter 23G and the power transmitting and receiving device 23H to cause the power transmitting and receiving device 23H to perform the contactless transmission of the electric power to the power transmitting and receiving device 48. In addition, the EMS 24 transmits a command to the ECU 44 to operate the power transmitting and receiving device 48 and the inverter device 43 of the electric vehicle 40, as appropriate. Accordingly, the EMS 24 can control the power transmitting and receiving device 48 and the inverter device 43 via the ECU 44 to charge the high voltage battery 41 of the electric vehicle 40 with the electric power from the power supply system 20 of the house HM. For this reason, the EMS 24 can charge the high voltage battery 41 with the electric power from the power supply system 20 of the house HM by supplying the electric power from the power supply system 20 of the house HM to the electric vehicle 40 via the contactless power supply device WPS. The electric power supplied from the power supply system 20 to the electric vehicle 40 may be the electric power generated by the solar power generator 21, the electric power from the power distribution system 12A, or both the electric power generated by the solar power generator 21 and the electric power from the power distribution system 12A. In a case where the electric power is supplied from the power supply system 20 to the electric vehicle 40 using only the electric power generated by the solar power generator 21, the EMS 24 controls the switch 23A to the open state.

Moreover, in a case where the high voltage battery 41 of the electric vehicle 40 is to discharge the electric power to the power supply system 20 of the house HM, the EMS 24 transmits a command to the ECU 44 to convert the output of the high voltage battery 41 into an alternating current having a predetermined frequency and operate the power transmitting and receiving device 23H, as appropriate. The predetermined frequency is set to 10 kHz or higher, for example. Thus, the EMS 24 can control the power transmitting and receiving device 48 and the inverter device 43 via the ECU 44, and can perform the contactless transmission of the electric power of the high voltage battery 41 of the electric vehicle 40 from the power transmitting and receiving device 48 to the power transmitting and receiving device 23H. In addition, the EMS 24 controls the power converter 23G and the power transmitting and receiving device 23H via the ECU 44, and performs a contactless reception of the electric power from the power transmitting and receiving device 48 of the electric vehicle 40. Accordingly, the EMS 24 can supply the electric power from the electric vehicle 40 to the power supply system 20 of the house HM, by discharging the electric power of the high voltage battery 41 of the electric vehicle 40 to the power supply system 20 of the house HM via the contactless power supply device WPS.

Moreover, in a case where the high voltage battery 41 of the electric vehicle 40 is to discharge to the power supply system 20 of the house HM, the EMS 24 controls the switch 23A to the open state, similar to the first example described above. Accordingly, the EMS 24 can prohibit the interconnection between the power grid 10 and the power supply system 20 of the house HM in the case where the electric vehicle 40 contactlessly receives the electric power supplied from the high voltage battery 41. For this reason, even in a case where the power converter 23G does not satisfy the interconnection requirements with respect to the power grid 10 or is not authenticated, the electrical power system 1 can supply the electric power from the high voltage battery 41 of the electric vehicle 40 to the power supply system 20 of the house HM.

Further, similar to the first example described above, in the case where the high voltage battery 41 of the electric vehicle 40 is to discharge to the power supply system 20 of the house HM, the EMS 24 controls some of the switches 23E among the plurality of switches 23E to the state connecting the power lines PL23 and PL25, and controls the remaining switches 23E to the state connecting the power lines PL24 and PL25. Accordingly, in the case where electric power is supplied from the high voltage battery 41 of the electric vehicle 40 to the power supply system 20 of the house HM, the EMS 24 can restrict the destination of the electric power to some of the electric loads 22. For this reason, even in a case where the electric power supplied from the high voltage battery 41 cannot cover the electric power to be supplied to all the electric loads 22, the EMS 24 can supply the electric power of the high voltage battery 41 to some of the electric loads 22, and can supply the electric power from the power distribution system 12A to the remaining electric loads 22. In addition, the switch 23E can selectively switch the connecting destination of the electric load 22 between the power lines PL23 and PL24. Hence, EMS 24 can avoid the electric vehicle 40 from being interconnected to the power grid 10, while supplying the electric power from the power distribution system 12A to the remaining electric loads 22. A part of the switches 23E to be controlled to the state connecting the power lines PL23 and PL25 may be fixed in advance, or may be varied by the setting operation performed by the resident of the residence HM. Further, as described above, the switch 23E may be provided on only some of the power lines PL25 among the plurality of power lines PL25, and the power lines PL25 not provided with the switch 23E may be connected to the power line PL23. In this case, when discharging from the high voltage battery 41 of the electric vehicle 40 to the power supply system 20 of the house HM, the EMS 24 may be configured to control some of the switches 23E among the plurality of switches 23E to the state connecting the power lines PL23 and PL25 and control the remaining switches 23E to the state connecting the power lines PL24 and PL25, similar to the above, or configured to control all of the switches 23E to the state connecting the power lines PL24 and PL25.

Moreover, similar to the first example described above, the EMS 24 may communicate with the PCS 21B of the solar power generator 21 via the transmission path, such as the one-to-one communication line or the like, to grasp the surplus power of the solar power generator 21, and charge the high voltage battery 41 of the electric vehicle 40 with the surplus power. Specifically, in the case where the surplus power of the solar power generator 21 is generated or is likely generated, the EMS 24 may check the energy storage rate of the high voltage battery 41 through communication with the ECU 44. In the case where the energy storage rate of the high voltage battery 41 is small relative to the predetermined reference, the EMS 24 may determine that the surplus power of the solar power generator 21 can be received, and charge the high voltage battery 41 of the electric vehicle 40 with the surplus power of the solar power generator 21. The state where the energy storage rate of the high voltage battery 41 is small relative to the predetermined reference may mean that the energy storage rate of the high voltage battery 41 is the predetermined reference or less, or that the energy storage rate of the high voltage battery 41 is less than the predetermined reference.

Further, similar to the first example described above, the EMS 24 may grasp the power shortage of the solar power generator 21 and discharge the electric power from the high voltage battery 41 of the electric vehicle 40 to the power supply system 20 of the house HM so as to compensate for the power shortage. Specifically, in the case where the power shortage is generated or is likely generated in the solar power generator 21, the EMS 24 may grasp the energy storage rate of the high voltage battery 41 through communication with the ECU 44. Further, in the case where the energy storage rate of the high voltage battery 41 is large relative to the predetermined reference, the EMS 24 may determine that the electric power of the high voltage battery 41 can be discharged, and discharge the electric power of the high voltage battery 41 to the power supply system 20 of the house HM. The state where the energy storage rate of the high voltage battery 41 is large relative to the predetermined reference may mean that the energy storage rate of the high voltage battery 41 is the predetermined reference or greater, or that the energy storage rate of the high voltage battery 41 exceeds the predetermined reference. Accordingly, the electrical power system 1 can compensate for a part or all of the power shortage of the solar power generator 21 with the electric power of the high voltage battery 41, and as a result, can reduce the amount of electric power used from the power grid 10 in the power supply system 20 of the house HM.

Accordingly, the EMS 24 can cause the high voltage battery 41 to absorb the power fluctuation of the solar power generator 21 in cooperation with the ECU 44 of the electric vehicle 40, similar to the first example described above. For this reason, the EMS 24 can obtain the same functions and effects as those obtainable by the first example described above.

In addition, in a case where the dynamic pricing is employed for the power supply from the power distribution system 12A to the power supply system 20, the EMS 24 may control the exchange of electric power between the power supply system 20 and the high voltage battery 41 according to the variation in the power rate of the electric power supplied from the power distribution system 12A with respect to the power supply system 20, similar to the first example described above. In the case where the power rate of the electric power supplied from the power distribution system 12A to the power supply system 20 is low relative to the prescribed reference, for example, the EMS 24 may check the energy storage rate of the high voltage battery 41 through communication with the ECU 44, similar to the first example described above. In the case where the energy storage rate of the high voltage battery 41 is small relative to the predetermined reference, the EMS 24 may determine that the surplus power of the solar power generator 21 can be received, and may control the inverter device 43 via the ECU 44 to charge the high voltage battery 41 of the electric vehicle 40 with the electric power supplied from the power distribution system 12A via the power supply system 20. On the other hand, in the case where the power rate of the electric power supplied from the power distribution system 12A with respect to the power supply system 20 is not low relative to the prescribed reference, that is, when the power rate is high relative to the prescribed reference, the EMS 24 may check the energy storage rate of the high voltage battery 41 through communication with the ECU 44, similar to the first example described above. Further, in the case where the energy storage rate of the high voltage battery 41 is large relative to the predetermined reference, the EMS 24 may determine that the high voltage battery 41 can be discharged, and may control the inverter device 43 via the ECU 44 to discharge the electric power of the high voltage battery 41 to the power supply system 20 of the house HM. Thus, similar to the first example described above, the EMS 24 can charge the high voltage battery 41 with the electric power from the power distribution system 12A in the case where the power rate of the power grid 10 is relatively low, and can discharge the electric power of the high voltage battery 41 to the power supply system 20 in the case where the power rate of the power grid 10 is relatively high. For this reason, the EMS 24 can obtain the same functions and effects as those obtainable by the first example described above.

Accordingly, the EMS 24 can absorb the power rate fluctuation of the electric power supplied from the power distribution system 12A to the power supply system 20, using the high voltage battery 41 of the electric vehicle 40, and can obtain the same functions and effects as those obtainable by the first example described above.

In addition, similar to the first example described above, the EMS 24 may discharge the electric power from the high voltage battery 41 of the electric vehicle 40 to the power supply system 20 of the house HM when the power supply from the power distribution system 12A to the power supply system 20 stops, that is, when a power failure occurs. In particular, the EMS 24 may grasp the energy storage rate of the high voltage battery 41 through communication with the ECU 44 when the power failure occurs. In the case where the energy storage rate of the high voltage battery 41 is large relative to the predetermined reference, the EMS 24 may determine that the high voltage battery 41 can be discharged, and discharge the electric power of the high voltage battery 41 to the power supply system 20 of the house HM. Hence, the EMS 24 can discharge the electric power of the high voltage battery 41 of the electric vehicle 40 and activate the electric load 22 of the house HM when the power failure occurs. For this reason, it is possible to obtain the same functions and effects as those obtainable by the first example described above.

In addition, similar to the first example described above, the EMS 24 may discharge the electric power from the high voltage battery 41 of the electric vehicle 40 to the power supply system 20 of the house HM only in the case where the electric power generated from the solar power generator 21 is small relative to the predetermined reference when the power failure occurs. In this case, the EMS 24 can obtain the same functions and effects as those obtainable by the first example described above.

Moreover, when the power failure occurs, the EMS 24 may control some of the switches 23E among the plurality of switches 23E to the state connecting the power lines PL23 and PL25, and control the remaining switches 23E to the state connecting the power lines PL24 and PL25, to discharge the electric power from the high voltage battery 41 of the electric vehicle 40 to the power supply system 20 of the house HM, similar to the first example described above. In this case, when the electric power is supplied from the high voltage battery 41 of the electric vehicle 40 to the power supply system 20 of the house HM, the EMS 24 can restrict the supplying destinations of the electric power to some of the electric loads 22, and exclude the remaining electric loads 22 from the supplying destination. For this reason, the EMS 24 can obtain the same functions and effects as those obtainable by the first example described above.

Accordingly, similar to the first example described above, the EMS 24 can effectively utilize the high voltage battery 41 of the electric vehicle 40 as the emergency power source of the power supply system 20 of the house HM when the power failure occurs.

### «Configuration of Quick Charger»

The quick charger 30 includes the charging cable 31, similar to the first example described above.

The charging cable 31 is provided to extend from the main body of the quick charger 30, and the connector that is electrically connectable to the charge port 46 of the electric vehicle 40 is provided on the tip end of the charging cable 31, similar to the first example described above. Thus, when the tip end of the charging cable 31 is connected to the charge port 46, it is possible to electrically connect the quick charger 30 and the DC power supply system of the electric vehicle 40. For this reason, the quick charger 30 can supply the electric power to the

DC power supply system of the electric vehicle 40 via the charging cable 31 and quickly charge the high voltage battery 41 of the electric vehicle 40.

### «Configuration of Electric Vehicle»

The electric vehicle 40 includes the power lines PL41 to PL45, the high voltage battery 41, the electric motor 42, the inverter device 43, the ECU (Electronic Control Unit) 44, a switch 47, the power transmitting and receiving device 48, and the charge port 46.

The power line PL41 is the DC power line connecting the high voltage battery 41 and the inverter device 43, similar to the first embodiment described above.

The power line PL42 is the AC power line connecting the inverter device 43 and the electric motor 42, similar to the first embodiment described above. Specifically, as illustrated in FIG. 5 and FIG. 6, the three-phase AC power line PL42 includes the U-phase line PL42u, the V-phase line PL42v, and the W-phase line PL42w, similar to the first example described above.

The power line PL43 is the AC power line connecting the electric motor 42 and the power transmitting and receiving device 48. Specifically, the power line PL43 connects the neutral point 43NP of the armature 42A of the electric motor 42 and one end of the power transmitting and receiving device 48.

The power line PL44 is the reference potential line that connects the other end of the power transmitting and receiving device 48, opposite to one end of the power transmitting and receiving device 48 to which the power line PL43 is connected, and the DC link 43DC of the inverter device 43.

For example, as illustrated in FIG. 5, a DC blocking capacitor 49 is provided on the power line PL44. Thus, in the case where the electric power is exchanged between the power supply system 20 of the house HM and the electric vehicle 40, a DC component is eliminated from the alternating current at the neutral point 43NP of the armature 42A generated between the power line PL44 and the armature 42A, and it is possible to generate an AC voltage including no DC component and having a predetermined frequency. The predetermined frequency is a frequency suitable for driving the contactless power supply device WPS, and are set to 10 kHz or higher as described above, for example.

Moreover, as illustrated in FIG. 6, the power line PL44 may be connected to the intermediate point between the balanced smoothing capacitors 43c1 and 43c2 of the DC link 43DC. Thus, the smoothing capacitors 43c1 and 43c2 can perform the same functions as the DC blocking capacitor 49. For this reason, it is possible to reduce an increase in the cost and weight of the electric vehicle 40, and to reduce the cost of the power supply system 20 of the house HM and the power supply system of the electric vehicle 40 as a whole.

The power line PL45 is the DC power line connecting the high voltage battery 41 and the charge port 46.

The high voltage battery 41 is a storage battery having a relatively high output voltage (for example, several hundred volts), similar to the first example described above. Similar to the first example described above, the high voltage battery 41 is provided with sensors capable of measuring various states of the high voltage battery 41, such as the current, the voltage, the temperature, or the like.

The electric motor 42 is the motor that drives the driving wheels of the electric vehicle 40, similar to the first example described above. The electric motor 42 is driven by the three-phase alternating current supplied from the inverter device 43. Specifically, as illustrated in FIG. 5 and FIG. 6, the electric motor 42 includes the armature 42A which is an example of a stator, and the armature 42A includes the U-phase winding 42u, the V-phase winding 42v, and the W-phase winding 42w which are connected by a Y-connection, similar to the first example described above.

Similar to the first example described above, the inverter device 43 converts the direct current supplied from the high voltage battery 41 via the power line PL41 into the three-phase alternating current having the predetermined voltage and the predetermined frequency, and outputs the three-phase alternating current to the power line PL42, thereby driving the electric motor 42. Specifically, as illustrated in FIG. 5 and FIG. 6, the inverter device 43 includes the smoothing circuit 43A, and the inverter circuit 43B, similar to the first example described above. In addition, the inverter device 43 is provided with sensors capable of measuring various states of the inverter device 43, such as the current, voltage, temperature, or the like, similar to the first example described above.

The smoothing circuit 43A suppresses and smoothens pulsations of the direct current output from the high voltage battery 41 and the direct current output from the inverter circuit 43B, similar to the first example described above. The smoothing circuit 43A includes the smoothing capacitor 43c of the DC link 43DC, similar to the first example described above. For example, as illustrated in FIG. 5, the smoothing capacitor 43c is provided on the power line between the positive line 43P and the negative line 43N of the DC link 43DC. The smoothing capacitor 43c may be configured by a single capacitor, or may be configured by a plurality of capacitors. For example, as illustrated in FIG. 6, the smoothing capacitor 43c is configured by a plurality of (in this example, two) smoothing capacitors 43c1 and 43c2 connected in series between the positive line 43P and the negative line 43N. Thus, it is possible to obtain the same functions and effects as those obtainable by the first example described above.

The positive line 43P and the negative line 43N of the DC link 43DC are connected to one end of the inverter circuit 43B, and the U-phase line PL42u, the V-phase line PL42v, and the W-phase line PL42w of the three-phase AC power line PL42 are connected to the other end of the inverter circuit 43B.

For example, as illustrated in FIG. 5 and FIG. 6, the inverter circuit 43B includes six semiconductor switches 43sw, similar to the first example described above. Specifically, the inverter circuit 43B includes a bridge circuit in which three switch legs are connected in parallel between the positive line 43P and the negative line 43N, where each switch leg has two semiconductor switches 43sw forming upper and lower arms and connected in series. Moreover, the U-phase line PL42u, the V-phase line PL42v, and the W-phase line PL42w are drawn out from the intermediate point of the three pairs of upper and lower arms of the bridge circuit, and are connected to the U-phase winding 42u, the V-phase winding 42v, and the W-phase winding 42w of the armature 42A, respectively. Further, a free wheeling diode 43d may be connected in parallel to each of the six semiconductor switches 43sw.

In the operating state of the electric vehicle 40, the inverter circuit 43B converts the direct current of the DC link 43DC into the alternating current and outputs the alternating current to the power line PL42, or converts the alternating current of the power line PL42 into the direct current and outputs the direct current to the DC link 43DC, by the switching operation of the semiconductor switch 43sw under the control of the ECU 44, similar to the first example described above.

For example, in the traveling state of the electric vehicle 40, the inverter circuit 43B converts the direct current supplied from the DC link 43DC into the three-phase alternating current having the predetermined voltage and the predetermined frequency, and outputs the three-phase alternating current to the electric motor 42. Thus, the inverter device 43 can drive the electric motor 42 and cause the electric vehicle 40 to travel. When the electric vehicle 40 decelerates, the inverter circuit 43B converts the AC power generated by the armature 42A into DC power and outputs the DC power to the DC link 43DC, according to a regenerative operation of the electric motor 42. Accordingly, the inverter device 43 can output the kinetic energy that is generated when the electric vehicle 40 travels to the DC link 43DC as the electrical energy (regenerative energy) to charge the high voltage battery 41, and also cause the electric vehicle 40 to generate the braking force by regeneration.

In addition, in a stopped state of the electric vehicle 40, the inverter circuit 43B converts the direct current of the DC link 43DC into the alternating current, and supplies the alternating current having the predetermined frequency to the power transmitting and receiving device 48 via the neutral point 43NP of the armature 42A and the power line PL42. The stopped state of the electric vehicle 40 refers to the state where the electric vehicle 40 cannot travel, and is the state where the accessory power source of the electric vehicle 40 is off (ACC-OFF) or the state where the ignition power source of the electric vehicle 40 is off (IG-OFF), for example. Hence, the inverter circuit 43B can supply the AC power from the high voltage battery 41 to the power supply system 20 of the house HM via the contactless power supply device WPS. As a result, the power supply system 20 of the house HM can activate the electric load 22 by the AC power supplied from the electric vehicle 40. In addition, when the electric vehicle 40 is in the stopped state, the inverter circuit 43B converts the alternating current supplied to the power line PL42 via the contactless power supply device WPS into the direct current, and outputs the direct current to the DC link 43DC. Thus, the inverter device 43 can charge the high voltage battery 41 with the AC power supplied from the power supply system 20 of the house HM.

Accordingly, in the present example, the electrical power system 1 can charge the high voltage battery 41 with the AC power supplied from the power supply system 20 of the house HM, and can discharge the electric power of the high voltage battery 41 from the electric vehicle 40 to the power supply system 20 of the house HM, using the inverter device 43, similar to the first example described above. For this reason, it is possible to obtain the same functions and effects as those obtainable by the first example described above.

The ECU 44 is the controller of the electric vehicle 40, similar to the first example described above.

For example, in the operating state of the electric vehicle 40, the ECU 44 outputs the control command to the inverter device 43 to control the driving of the electric motor 42 via the inverter device 43, similar to the first example described above.

Further, similar to the first example described above, in the stopped state of the electric vehicle 40, the ECU 44 controls the inverter device 43 under the control of the EMS 24 to convert the alternating current of the power lines PL43 and PL42 into the direct current and output the direct current to the DC link 43DC. Accordingly, the ECU 44 can charge the high voltage battery 41 with the AC power supplied from the power supply system 20 of the house HM in response to the command from the EMS 24.

Moreover, in the stopped state of the electric vehicle 40, the ECU 44 controls the inverter device 43 under the control of the EMS 24 to convert the direct current of the DC link 43DC into the alternating current and output the alternating current to the power lines PL42 and PL43 and the transmitting and receiving device 48. Accordingly, the ECU 44 can discharge the electric power of the high voltage battery 41 to the power supply system 20 of the house HM in response to the command from the EMS 24.

In addition, the ECU 44 transmits the information of the sensors provided on the high voltage battery 41 and the sensors provided on the inverter device 43 to the EMS 24, similar to the first example described above. Thus, the EMS 24 located in the higher level can grasp the states of the high voltage battery 41 and the inverter device 43.

The switch 47 is provided on the power line PL43, and is configured to be able to electrically open and close the power line PL43 under a control of the ECU 44. For example, the switch 47 is controlled to the open state in the operating state of the electric vehicle 40, and is controlled to the closed state in the stopped state of the electric vehicle 40. Hence, it is possible to cut off the supply of the electric power from the inverter device 43 and the armature 42A of the electric motor 42 to the power transmitting and receiving device 48 during the operating state of the electric vehicle 40.

The power transmitting and receiving device 48 is an interface having one end thereof connected to the power line PL43 and the other end thereof connected to the power line PL44, and configured to contactlessly exchange the electric power with the power supply system 20 of the house HM under a control of the ECU 44. As described above, the power transmitting and receiving device 48 forms the contactless power supply device WPS together with the power transmitting and receiving device 23H of the power supply system 20 of the house HM.

For example, the power transmitting and receiving device 23H is provided on the ground of the parking space of the house HM, and the power transmitting and receiving device 48 is provided on a lower surface of a floor of the electric vehicle 40. Thus, by parking the electric vehicle 40 in the parking space such that the power transmitting and receiving device 48 on the lower surface of the floor of the electric vehicle 40 is positioned above the power transmitting and receiving device 23H on the ground, it is possible to achieve a state where the electric power can be contactlessly exchanged between the power transmitting and receiving device 23H and the power transmitting and receiving device 48.

Moreover, a surface of the power transmitting and receiving device 23H may normally be covered with a protective member, and the protective member may be movable from the state covering the power transmitting and receiving device 23H to expose the power transmitting and receiving device 23H upward when exchanging the electric power with the power transmitting and receiving device 48. Similarly, a surface (lower surface) of the power transmitting and receiving device 48 may be covered with a protective member in the operating state of the electric vehicle 40, and the protective member may be movable from the state covering the power transmitting and receiving device 48 to expose the power transmitting and receiving device 48 downward when exchanging the electric power with the power transmitting and receiving device 23H. Thus, it is possible to more appropriately and contactlessly exchange the electric power between the power transmitting and receiving device 23H and the power transmitting and receiving device 48, while minimizing contamination and failure of the power transmitting and receiving device 23H and the power transmitting and receiving device 48 and preventing electric shock caused by exposure of the power transmitting and receiving device 23H and the power transmitting and receiving device 48.

For example, in a case where the positional relationship between the power transmitting and receiving device 23H and the power transmitting and receiving device 48 falls within a predetermined range in which the electric power can be transmitted and received therebetween, the EMS 24 may control the position of the protective member of the power transmitting and receiving device 23H so as to expose an upper portion of the power transmitting and receiving device 23H. Similarly, in a case where the positional relationship between the power transmitting and receiving device 23H and the power transmitting and receiving device 48 falls within the predetermined range in which the electric power can be transmitted and received therebetween, the ECU 44 may control the position of the protective member of the power transmitting and receiving device 48 so as to expose a lower portion of the power transmitting and receiving device 48. In these cases, the positional relationship between the power transmitting and receiving device 23H and the power transmitting and receiving device 48 may be determined by each of EMS 24 and ECU 44, or may be determined by one of the EMS 24 and the ECU 44, or the other of the EMS 24 and the ECU 44 may control the position of the protective member in response to a command from the one of the EMS 24 and the ECU 44. The position of the protective member is controlled in response to a request from the resident of the house HM or the user of the electric vehicle 40, for example. The resident of the residence HM or the user of the electric vehicle 40 can transmit the request to the EMS 24 or the ECU 44 by performing a predetermined operation on an operation panel disposed in the parking space of the residence HM or by performing a predetermined operation on an operation terminal capable of making a wireless communication with the EMS 24 or the ECU 44. The operation terminal may be a dedicated terminal or a general-purpose portable terminal, such as a smartphone or the like, for example. In addition, the position of the protective member may be automatically controlled according to whether or not conditions of the positional relationship are satisfied between the power transmitting and receiving device 23H and the power transmitting and receiving device 48. In this case, it is unnecessary for the resident of the house HM and the user of the electric vehicle 40 to perform an operation, and it is possible to provide a further improved convenience to the resident of the house HM and the user of the electric vehicle 40.

### <Functions>

Next, the functions of the electrical power system, the power supply apparatus, the power converter, and the controller according to the present example will be described.

In the present embodiment, the electrical power system includes a storage battery, an electric motor, a first power converter, a power supply system, a power connection part, and a first power line. The electrical power system is the electrical power system 1 described above, for example. The storage battery is the high voltage battery 41 described above, for example. The electric motor is the electric motor 42 described above, for example. The first power converter is the inverter device 43 described above, for example. The power supply system is the power supply system 20 described above, for example. The power connection part is the contactless power supply device WPS, for example. Specifically, the storage battery and the electric motor are provided in a vehicle. The vehicle is the electric vehicle 40 described above, for example. The first power converter is electrically connected to both the storage battery and the electric motor in the vehicle, and converts an output of the storage battery into an alternating current to drive the electric motor. The power supply system is provided in a house or a facility. The house or the facility is the house HM described above, for example. The power connection part connects the power supply system and the first power line so that the electric power is exchangeable therebetween. The first power line connects a neutral point of an armature of the electric motor and a first power transmitting and receiving device in the vehicle. The neutral point of the armature is the neutral point 42NP of the armature 42A described above, for example. The storage battery can be charged with the electric power supplied from the power supply system via the first power converter, the neutral point, the first power line, the first power transmitting and receiving device, and a second power transmitting and receiving device, and can discharge the electric power to the power supply system.

Specifically, the power connection part may include the first power transmitting and receiving device and the second power transmitting and receiving device that are provided in the vehicle and the power supply system, respectively, and can transmit and receive the electric power to and from each other. The first power transmitting and receiving device is the power transmitting and receiving device 48 described above, for example. The second power transmitting and receiving device is the power transmitting and receiving device 23H described above, for example. The first power transmitting and receiving device may be connected to a side of the first power line opposite from a side of the neutral point.

Accordingly, the electrical power system can cause the existing first power converter provided in the vehicle to perform the conversion between direct current, which is the output of the storage battery when the electric power is exchanged between the vehicle provided with the storage battery and the power supply system of the house or the like, and the alternating current used in the power supply system of the house or facility. For this reason, it is not necessary to provide an additional device for performing the conversion between the alternating current and the direct current, and the electrical power system can exchange the electric power between the vehicle and the house or the like using a simpler configuration.

Moreover, in the present embodiment, the electrical power system may include a power supply apparatus. The power supply apparatus is the power supply apparatus 23 described above, for example. Specifically, the power supply apparatus may be provided in the power supply system and electrically connected to each of an electric load in the house or the facility, the power connection part (for example, the second power transmitting and receiving device), and a predetermined power source. The electric load is the electric load 22 described above, for example. The predetermined power source is the power distribution system 12A of the power grid 10 or the solar power generator 21 described above, for example. Further, in the electrical power system, the power supply apparatus may supply an alternating current of a predetermined power source to the first power line via the power connection part, and the first power converter may convert the alternating current supplied to the first power line into a direct current and output the direct current to the storage battery, to charge the storage battery with the electric power of the predetermined power source. Specifically, in the electrical power system, the power supply apparatus may supply the alternating current of the predetermined power source to the first power transmitting and receiving device via the second power transmitting and receiving device, and the first power converter may convert the alternating current received by the first power transmitting and receiving device into the direct current and output the direct current to the storage battery, to charge the storage battery with the electric power of the predetermined power source. In the electrical power system, the first power converter may convert the output of the storage battery into the alternating current and output the alternating current to the armature side, the alternating current may be supplied to the power supply system via the neutral point, the first power line, and the power connection part, and the power supply apparatus may supply the electric power to the electric load, to discharge the electric power of the storage battery to the electric load. Specifically, in the electrical power system, the first power converter may convert the output of the storage battery into the alternating current and output the alternating current to the armature side to supply the alternating current to the second power transmitting and receiving device via the neutral point, the first power line, and the first power transmitting and receiving device, and the power supply apparatus may supply the electric power received by the second power transmitting and receiving device to the electric load, to discharge the electric power of the storage battery to the electric load.

The power supply apparatus may be capable of contactlessly exchanging the electric power with the vehicle including the storage battery, the electric motor, the first power converter electrically connected to both the storage battery and the electric motor and configured to convert the output of the storage battery into the alternating current to drive the electric motor, and the first power line extending from the neutral point of the armature of the electric motor, via the power connection part (for example, the first power transmitting and receiving device connected to the tip end of the first power line, and the second power transmitting and receiving device provided in the residence or the facility). Specifically, the power supply apparatus may be electrically connected to each of the electric load in the house or the facility, and the predetermined power source. Moreover, the power supply apparatus may charge the storage battery with the electric power of the predetermined power source by supplying the alternating current of the predetermined power source to the first power line via the power connection part (for example, the first power transmitting and receiving device and the second power transmitting and receiving device). Further, the power supply apparatus may discharge the electric power of the storage battery to the electric load by supplying the alternating current supplied from the first power line to the electric load via the power connection part (for example, the first power transmitting and receiving device and the second power transmitting and receiving device).

In addition, in the present embodiment, the power converter may be provided in the vehicle including the storage battery, the electric motor, and the first power line extending from the neutral point of the armature of the electric motor, and may be electrically connected to both the storage battery and the electric motor, and convert the direct current of the storage battery into the alternating current to drive the electric motor. The power converter is the inverter device 43 described above, for example. The power converter may convert an alternating current supplied from a predetermined power source outside the vehicle to the first power line via a power connection part (for example, the contactless electric power exchange between the first power transmitting and receiving device connected to the tip end of the first power line and the second power transmitting and receiving device outside the vehicle) into the direct current and output the direct current to the storage battery, to charge the storage battery with the electric power of the predetermined power source. The power converter may convert the output of the storage battery into the alternating current and output the alternating current to the armature side, and supply the alternating current to the electric load in the house or the facility via the power connection part (for example, the contactless electric power exchange between the first power transmitting and receiving device and the second power transmitting and receiving device) to discharge the electric power of the storage battery to the electric load.

The controller controls the electric power system including the storage battery provided in the vehicle, the electric motor provided in the vehicle, the first power converter electrically connected to both the storage battery and the electric motor and configured to convert the output of the storage battery into the alternating current and drive the electric motor, the power supply system provided in the house or the facility, the power connection part configured to connect the power supply system and the first power line such that the electric power is exchangeable therebetween, the first power line provided in the vehicle and configured to electrically connect the neutral point of the armature of the electric motor and the first power transmitting and receiving device, and the power supply apparatus provided in the power supply system and electrically connected to each of the electric load, the power connection part, and a predetermined power source in the house or the facility. The controller is the EMS 24, for example. Specifically, the controller may control the power supply apparatus to supply the alternating current of the predetermined power source to a power line via the power connection part, and control the power converter to convert the alternating current supplied to the power line into the direct current and output the direct current to the storage battery, to charge the storage battery with the electric power of the predetermined power source. More specifically, the controller may control the power supply apparatus to transmit the alternating current of the predetermined power source to the first power transmitting and receiving device via the second power transmitting and receiving device, and control the first power converter to convert the alternating current received by the first power transmitting and receiving device into the direct current and output the direct current to the storage battery, to charge the storage battery with the electric power of the predetermined power source. Further, the controller may control the power converter to convert the output of the storage battery into the alternating current and output the alternating current to the armature side, and supply the alternating current to the power supply system via the neutral point of the armature, the power line, and the power connection part, and control the power supply apparatus to supply the electric power thereof to the electric load, to discharge the electric power of the storage battery to the electric load. More specifically, the controller may control the first power converter to convert the output of the storage battery into the alternating current and output the alternating current to the armature side, and transmit the alternating current to the second power transmitting and receiving device via the neutral point, the first power line, and the first power transmitting and receiving device, and control the power supply apparatus to supply the electric power received by the second transmitting and receiving device to the electric load, to discharge the electric power of the storage battery to the electric load.

Accordingly, the electrical power system or the like can charge the storage battery of the vehicle with the electric power of the predetermined power source of the house or the like, and discharge electric the power of the storage battery of the vehicle to the electric load of the house or the facility to activate the electric load.

Moreover, in the present embodiment, the power supply system may be electrically connected to an AC power distribution system that distributes an AC power of a power grid to the house or the facility. The power grid is the power grid 10 described above, for example. The AC power distribution system is the power distribution system 12A described above, for example. A first switch may be provided to open and close the electrical connection between the AC power distribution system and the power supply system. The first switch is the switch 23A, for example.

Hence, in a case where the electric power from the storage battery of the vehicle is discharged to the power supply system of the house or the like via the first power transmitting and receiving device and the second power transmitting and receiving device, for example, the electrical power system or the like can prohibit the interconnection between the power supply system on the vehicle side and the power grid by controlling the first switch to the open state. For this reason, even in a case where it is difficult for a device related to the reception of the electric power from the storage battery of the vehicle in the power supply system of the house or the like to satisfy the interconnection requirements, for example, it is possible to achieve the electric power exchange between the vehicle and the power supply system of the house or the like.

Further, in the present embodiment, the power supply system may be electrically connected to an AC power distribution system that distributes an AC power of the power grid to the house or the facility. The power supply system may be provided with a second power converter configured to convert an alternating current into an alternating current between the second power transmitting and receiving device and the AC power distribution system. The second power converter is the power converter 23G, for example. The second power converter may satisfy the interconnection requirements with respect to the power grid.

Accordingly, the electrical power system 1 or the like can achieve the electric power exchange between the vehicle and the power supply system of the house or the like.

In addition, in the present embodiment, the power supply system may include a plurality of load systems configured to supply the electric power to the electric loads in the house or the facility. The plurality of load systems are the plurality of power lines PL25 described above, for example. At least some of the plurality of load systems may be provided with a second switch configured to switch between a state where the load system is electrically connected to only one of the second power transmitting and receiving device and the predetermined power source and a state where the load system is electrically connected to only the other of the second power transmitting and receiving device and the predetermined power source. The second switch is the switch 23E described above, for example.

Thus, in a case where the electric power from the storage battery of the vehicle is discharged to the power supply system of the house or the like, for example, the electrical power system or the like can restrict the supply of the electric power from the storage battery of the vehicle to only some of the plurality of load systems by controlling the second switch to the state where the target load system is connected to only the predetermined power source. For this reason, even in the case where the electric power supplied from the storage battery cannot cover the electric power to be supplied to all of the plurality of load systems, the electrical power system or the like can supply the electric power of the high voltage battery 41 to some of the load systems and supply the electric power from the predetermined power source to the remaining load systems. Moreover, the second switch can selectively switch the connecting destination of the load system between the storage battery side and the predetermined power source side. For this reason, in a case where the predetermined power source is the power grid, for example, the electrical power system or the like can avoid the vehicle from being interconnected to the power grid while achieving power supply of the electric power from the power supply system to the remaining load systems.

Further, in the present embodiment, a DC blocking capacitor may be provided which acts so that the alternating current at the neutral point of the armature does not include a DC component (offset component). The DC blocking capacitor is the DC blocking capacitor 49 described above, for example. In addition, by connecting the power line PL44 to the intermediate point between the balanced smoothing capacitors 43c1 and 43c2 described above, for example, it is possible to obtain the same effects as the DC blocking capacitor.

Hence, the electrical power system or the like can generate a single-phase AC voltage that does not include the DC component at the neutral point of the armature when exchanging the electric power between the vehicle and the house or the like.

Moreover, in the present embodiment, the DC blocking capacitor may be provided between the other end of the first power transmitting and receiving device, opposite to one end of the first power transmitting and receiving device to which the first power line is connected, and a negative line of a DC link of the first power converter. The DC blocking capacitor is the DC blocking capacitor 49 described above, for example.

Accordingly, the electrical power system or the like can generate an AC voltage having a frequency suitable for contactless power transmission between the first power transmitting and receiving device and the second power transmitting and receiving device, which does not include the DC component at the neutral point of the armature when exchanging the electric power between the vehicle and the house or the like.

Further, in the present embodiment, the first power converter may include a plurality of smoothing capacitors connected in series between a positive line and the negative line of the DC link. The DC link is the DC link 43DC described above, for example. The positive line and the negative line are the positive line 43P and the negative line 43N described above, for example. The plurality of smoothing capacitors are the smoothing capacitors 43c1 and 43c2, for example. A second power line may be provided to connect the power connection part (for example, the other end of the first power transmitting and receiving device opposite to the one end to which the first power line is connected) and the intermediate point between two mutually adjacent smoothing capacitors among the plurality of smoothing capacitors. The second power line is the power line PL44 in FIG. 6 described above, for example.

Thus, the circuit configuration including the two smoothing capacitors and the second power line can perform the same functions as the DC blocking capacitor. For this reason, the electrical power system or the like can reduce an increase in the weight and cost of the vehicle when achieving the exchange of the electric power between the vehicle and the house or the like.

In addition, in the present embodiment, the first power transmitting and receiving device and the second power transmitting and receiving device may correspond to a transformer in which a primary winding on the power transmission side and a secondary winding on the power reception side are isolated.

Accordingly, the electrical power system or the like can achieve a contactless exchange of the electric power between the vehicle and the power supply system 20 of the house or the like, by electromagnetic induction between the first power transmitting and receiving device and the second power transmitting and receiving device.

Moreover, in the present embodiment, the first power transmitting and receiving device and the second power transmitting and receiving device may transmit the electric power from the power transmission side to the power reception side by magnetic resonance.

As a result, a distance over which the electric power is exchangeable between the first power transmitting and receiving device and the second power transmitting and receiving device can be made relatively long. For this reason, restrictions on a positional relationship between the first power transmitting and receiving device and the second power transmitting and receiving device can be relatively relaxed, and the electrical power system or the like can provide improved convenience to the user.

In the present embodiment, the electrical power system may include a first protective part and a second protective part configured to cover the first power transmitting and receiving device and the second power transmitting and receiving device, respectively. In addition, the first protective part and the second protective part may expose the first power transmitting and receiving device and the second power transmitting and receiving device, respectively, when the vehicle is parked in a predetermined range defined by a positional relationship between the vehicle and the second power transmitting and receiving device.

Accordingly, the electrical power system or the like can more appropriately and contactlessly exchange the electric power between the first power transmitting and receiving device and the second power transmitting and receiving device, while minimizing contamination and failure of the first power transmitting and receiving device and second the power transmitting and receiving device and preventing electric shock caused by exposure of the first power transmitting and receiving device and the second power transmitting and receiving device.

In the present embodiment, the first protective part and the second protective part may automatically expose the first power transmitting and receiving device and the second power transmitting and receiving device, respectively, when the vehicle is parked in a predetermined range.

Thus, the electrical power system or the like can eliminate the need for a person, such as the resident of the house or the like, and the user of the electric vehicle, to perform an operation on the first and second protective parts, and can provide improved convenience to the person.

In the present embodiment, the power supply system may include a renewable energy derived power source. The a renewable energy derived power source is the solar power generator 21 described above, for example.

Accordingly, in a case where the output of the renewable energy derived power source is relatively large, for example, the electrical power system or the like can charge the storage battery of the vehicle with the electric power of the renewable energy derived power source, and in a case where the output of the renewable energy derived power source is relatively small, the electrical power system or the like can discharge the electric power of the storage battery to the power supply system of the house or the like. For this reason, the electrical power system or the like can absorb the output fluctuation of the renewable energy derived power source by the storage battery of the vehicle.

In the present embodiment, the power supply system is connected to the power grid. The power grid is the power grid 10 described above, for example. The storage battery may be charged with the electric power supplied from the power grid via the power supply system in a case where the power rate of the power grid is relatively low, and may discharge the electric power to the power supply system in a case where the power rate of the power grid is relatively high.

Hence, the electrical power system or the like can absorb the power rate fluctuation of the power grid due to the dynamic pricing, using the storage battery of the vehicle, and can reduce the cost of the electric power consumed by the electric load of the electrical power system of the house or the facility.

According to the present disclosure, the electric power can be exchanged between the vehicle provided with the storage battery and the house or the like using a simpler configuration.

Although the embodiments are described above in detail, the present disclosure is not limited to the specific embodiments, and various variations and modifications may be made within the scope of the subject matter recited in the claims.

1. An electrical power system comprising:
a storage battery provided in a vehicle;
an electric motor provided in the vehicle;
a first power converter electrically connected to both the storage battery and the electric motor in the vehicle, and configured to convert an output of the storage battery into an alternating current to drive the electric motor;
a first power line extending from a neutral point of an armature of the electric motor in the vehicle;
a power supply system provided in a house or a facility; and
a power connection part configured to electrically connect the power supply system and the first power line such that electrical power is exchangeable therebetween, wherein:
the storage battery is chargeable with the electric power supplied from the power supply system via the power connection part, the first power line, the neutral point, and the first power converter, and
the electric power is dischargeable from the storage battery to the power supply system via the first power converter, the neutral point, the first power line, and the power connection part.

2. The electrical power system as claimed in claim 1, further comprising:
a power supply apparatus provided in the power supply system and electrically connected to each of an electric load in the house or the facility, the power connection part, and a predetermined power source, wherein:
the power supply apparatus supplies an alternating current of the predetermined power source to the first power line via the power connection part, and the first power converter converts the alternating current supplied to the neutral point via the first power line into a direct current and outputs the direct current to the storage battery, thereby charging the storage battery with an electric power of the predetermined power source, and
the first power converter converts the output of the storage battery into an alternating current and supplies the alternating current to the power supply system via the neutral point, the first power line, and the power connection part, and the power supply apparatus supplies an electric power to the electric load, thereby discharging the electric power of the storage battery to the electric load.

3. The electrical power system as claimed in claim 1, wherein:
the power supply system is electrically connected to an AC power distribution system that distributes an AC power of a power grid to the house or the facility, and further comprising:
a first switch configured to electrically open and close between the AC power distribution system and the power supply system.

4. The electrical power system as claimed in claim 1, wherein:
the power supply system includes a plurality of load systems configured to supply an electric power to the electric load in the house or the facility, and
at least some of the plurality of load systems are provided with a second switch configured to switch between a state where the load system is electrically connected to only one of the power connection part and the predetermined power source and a state where the load system is electrically connected to only the other of the power connection part and the predetermined power source.

5. The electrical power system as claimed in claim 1, further comprising:
a DC blocking capacitor configured to eliminate a DC component from the alternating current at the neutral point.

6. The electrical power system as claimed in claim 1, wherein:
the first power converter includes a plurality of smoothing capacitors coupled in series between a positive line and a negative line of a DC link, and further comprising:
a second power line having one end thereof electrically connected to an intermediate point between two mutually adjacent smoothing capacitors among the plurality of smoothing capacitors and the other end thereof electrically connected to the power connection part.

7. The electrical power system as claimed in claim 1, wherein the power connection part includes a charge and discharge port provided on a tip end of the first power line in the vehicle, and a charging and discharging cable provided to extend from the power supply system and having a tip end thereof electrically connectable to the charge and discharge port.

8. The electrical power system as claimed in claim 7, further comprising:
a filter capacitor configured to eliminate a high-frequency component of an output current when the first power converter converts the output of the storage battery into the alternating current.

9. The electrical power system as claimed in claim 8, wherein the filter capacitor is provided in the power supply system.

10. The electrical power system as claimed in claim 7, further comprising:
a DC blocking capacitor provided in the power supply system and configured to eliminate a DC component from the alternating current at the neutral point.

11. The electrical power system as claimed in claim 1, wherein:
the power connection part includes a first power transmitting and receiving device and a second power transmitting and receiving device that are provided in the vehicle and the power supply system, respectively, and configured to transmit and receive an electric power therebetween, and
the first power transmitting and receiving device is electrically connected a side of the first power line opposite from a side of the neutral point.

12. The electrical power system as claimed in claim 11, wherein:
the power supply system is electrically connected to an AC power distribution system that distributes an AC power of a power grid to the house or the facility,
the power supply system is provided with a second power converter that converts an alternating current into an alternating current between the second power transmitting and receiving device and the AC power distribution system, and
the second power converter satisfies interconnection requirements with respect to the power grid.

13. The electrical power system as claimed in claim 11, further comprising:
a DC blocking capacitor, provided between the other end of the first power transmitting and receiving device opposite to one end of the first power transmitting and receiving device connected to the first power line and a negative line of a DC link of the first power converter, and configured to eliminate a DC component from the alternating current at the neutral point.

14. The electrical power system as claimed in claim 11, wherein the first power transmitting and receiving device and the second power transmitting and receiving device correspond to a transformer in which a primary winding on a power transmission side and a secondary winding on a power reception side are isolated.

15. The electrical power system as claimed in claim 11, wherein the first power transmitting and receiving device and the second power transmitting and receiving device transmit an electric power from a power transmission side to a power reception side by magnetic resonance.

16. The electrical power system as claimed in claim 11, further comprising:
a first protective part and a second protective part that cover the first power transmitting and receiving device and the second power transmitting and receiving device, respectively,
wherein the first protective part and the second protective part respectively expose the first power transmitting and receiving device and the second power transmitting and receiving device, respectively, when the vehicle is parked in a predetermined range defined by a positional relationship between the vehicle and the second power transmitting and receiving device.

17. The electrical power system as claimed in claim 16, wherein the first protective part and the second protective part automatically expose the first power transmitting and receiving device and the second power transmitting and receiving device, respectively, when the vehicle is parked in the predetermined range.

18. The electrical power system as claimed in claim 1, wherein the power supply system includes a renewable energy derived power source.

19. The electrical power system as claimed in claim 1, wherein:
the power supply system is electrically connected to a power grid, and
the storage battery is charged with an electric power supplied from the power grid via the power supply system when a power rate of the power grid is relatively low, and discharges the electric power to the power supply system when the power rate of the power grid is relatively high.

20. A power converter provided in a vehicle including a storage battery, an electric motor, and a power line extending from a neutral point of an armature of the electric motor, the power converter being electrically connected to both the storage battery and the electric motor and converting a direct current of the storage battery into an alternating current to drive the electric motor, the power converter performing a process comprising:
converting an alternating current supplied from a predetermined power source outside the vehicle via a power connection part, the power line, and the neutral point into a direct current and outputting the direct current to the storage battery to charge the storage battery with an electric power of the predetermined power source; and
discharging an electric power of the storage battery to an electric load in a house or a facility, by converting an output of the storage battery into an alternating current, and supplying the alternating current to the electric load via the neutral point, the power line, and the power connection part.
